(19) United States
(12) Patent Application Publication
(10) Pub. No.: US 2026/0036546 A1
(43) Pub. Date: Feb. 5, 2026

(54) ELECTROPHORESIS CASSETTE AND COMB

(71) Applicant: LIFE TECHNOLOGIES CORPORATION, Carlsbad, CA (US)

(72) Inventors: Syrus Merrill JAFFE, Carlsbad, CA (US); Neil OLSON, San Diego, CA (US)

(21) Appl. No.: 19/288,695

(22) Filed: Aug. 1, 2025

Related U.S. Application Data
(60) Provisional application No. 63/679,541, filed on Aug. 5, 2024.

(51) Int. Cl. G01N 27/447

(52) U.S. Cl. CPC G01N 27/44704; G01N 27/44782

(57) ABSTRACT

An assembly for gel electrophoresis includes a gel cassette and a comb. The gel cassette includes a retainer plate and a divider plate coupled to form a cavity therebetween. The comb includes an elongated body having a first end and a second end, an intermediate portion connected to the elongated body and extending between the first and second ends, the intermediate portion having a third end adjacent the first end and a fourth end adjacent the second end, and a plurality of teeth extending from the intermediate portion. The plurality of teeth is spaced apart from at least one of the third end and the fourth end. In response to the comb being received in the gel cassette, the intermediate portion is received in the cavity such that the third and the fourth ends are configured to engage an internal edge of the cavity.

### CROSS-REFERENCE TO RELATED APPLICATIONS

This application claims priority to U.S. Provisional Patent Application No. 63/679,541, filed on Aug. 5, 2024, and entitled “Electrophoresis Cassette and Comb,” the entire contents of which is incorporated by reference herein.

### BACKGROUND

Gel electrophoresis is a common procedure for the separation of biological molecules, such as DNA, RNA, polypeptides, and proteins. In gel electrophoresis, the molecules are separated into bands according to the rate at which an imposed electric field causes them to migrate through a filtering gel.

The basic unit used in this technique consists of a gel enclosed in a glass tube or sandwiched as a slab between glass or plastic plates. Gels have an open molecular network structure, defining pores which are saturated with an electrically conductive buffered solution. These pores are large enough to admit passage of the migrating macromolecules through the gel.

The gel is placed in a chamber in contact with buffer solutions which make electrical contact between the gel and the cathode or anode of an electrical power supply. A sample containing the macromolecules and a tracking dye is placed on top of the gel. An electric potential is applied to the gel causing the sample macromolecules and tracking dye to migrate toward the bottom of the gel. The electrophoresis is halted just before the tracking dye reaches the end of the gel. The locations of the bands of separated macromolecules are then determined. By comparing the distance moved by particular bands in comparison to the tracking dye and macromolecules of known size, the size of other macromolecules can be determined.

Polyacrylamide gels are commonly used for electrophoresis. Other gels suitable for electrophoresis include agarose gels and starch gels. Polyacrylamide gel electrophoresis or PAGE is popular because the gels are optically transparent, electrically neutral and can be made with a range of pore sizes.

Methods of making PAGE gels are known. See Hames and Rickwood, Gel Electrophoresis of Proteins (2d ed. Oxford University Press, 1990); Andrews, Electrophoresis (2nd ed. Oxford University Press, 1986). In general, concentrated stock solutions containing acrylamide monomer, a crosslinker such as bisacrylamide, gel buffers (e.g., Tris-glycine), and denaturing agents such as sodium dodecyl sulphate (“SDS”) are prepared. These stock solutions can be stored until a gel is needed. To manufacture a gel, the stock solutions are mixed with water in proportions according to the final desired concentrations of the various constituents. Polymerization of the gel is accomplished by adding an oxidizing agent polymerization initiator such as ammonium persulfate ((NH4)₂(SO4)₂; APS). Often a polymerization accelerator such as tetramethylethylenediamine (TEMED) is added to facilitate rapid polymerization.

In some cases, a “stacking gel” is used. A stacking gel is a gel poured on top of a resolving gel. The stacking gel typically has a lower pH (6.8 vs. 8.8) and a lower percentage of polyacrylamide (4% vs. 8-12%) than the resolving gel. The purpose of the stacking gel is to concentrate and focus the sample volume so that the molecules of interest (e.g., proteins) enter the resolving gel in a tight band having a volume much less than what was loaded.

Glass has typically been used to make molds for electrophoresis gels. However, glass suffers from the disadvantage that it is fragile, difficult to form into particular shapes and expensive. It is easier and more economical to form gel molds from plastic materials by processes such as injection molding. However, using plastic molds for casting electrophoresis gels may contribute to decreased resolution of the separated macromolecule bands. Decreased resolution of the macromolecule bands may be caused by macromolecules moving faster on the surface of the gel in contact with the mold than in the interior of the gel. This variation in migration rates between the surface of the gel and the interior lead may lead to smearing of the macromolecule bands.

In addition to the decreased resolution that may occur in a gel, another disadvantage of current methods for creating and performing gels, such as SDS-PAGE gels, is that the use of the gel is limited by the amount of sample that may be loaded into the gel. It may be desirable to have the ability to apply greater volumes of samples to the gels. It can be desirable to produce gels of greater thickness or to produce gels with wells with an increased well-volume proportional to the increased thickness of the gel. However, this may lead to gels that require proportionately greater current for a given field strength. Greater current for a given field strength may lead to greater heat buildup in the gels which in turn may lead to decreased resolution and performance. Another problem that may arise with thicker gels is that protein bands may transfer less efficiently in downstream applications, such as western blotting.

One solution for increasing sample volume in a gel may be to increase the depth of the wells of a particular width and gel thickness. However, the increased volumes may produce increased sample heights above the gel, leading to thicker protein band starting zones, and lower resolution. If a stacking gel height is proportionately increased, then the resolving gel length will be proportionately decreased, also contributing to reduced resolution in a given gel cassette.

What is needed is a gel cassette and comb that enables gel of a particular thickness having a well capable of holding a sample volume that is at least double the well volume of the current methods, while maintaining the same sample height above the gel as a standard well of particular width and thickness.

### SUMMARY

One embodiment described herein is an assembly for gel electrophoresis comprising: a gel cassette comprising a retainer plate and a divider plate coupled to form a cavity between the retainer plate and the divider plate; and a comb comprising an elongated body having a first end and a second end, an intermediate portion connected to the elongated body and extending between the first end and the second end, the intermediate portion having a third end and a fourth end, the third end adjacent the first end of the elongated body, the fourth end adjacent the second end of the elongated body, the intermediate portion received in the cavity, and a plurality of teeth extending from the intermediate portion between the first end and the second end, the plurality of teeth spaced apart from at least one of the third end and the fourth end. In one aspect, the plurality of teeth includes a first tooth nearest the third end of the intermediate portion, the first tooth has a first width, the first tooth is spaced apart from the third end of the intermediate portion by a first distance, and the first distance is greater than the first width. In another aspect, the plurality of teeth includes a second tooth nearest the fourth end of the intermediate portion, the second tooth has a second width, the second tooth is spaced apart from the fourth end of the intermediate portion by a second distance, and the second distance is greater than the second width. In another aspect, the first width is identical to the second width. In another aspect, the first distance is identical to the second distance. In another aspect, each tooth of the plurality of teeth has an identical width. In another aspect, the plurality of teeth includes a third tooth between the first tooth and the second tooth, the third tooth has a third width, and the third width is greater than the first width and/or the second width. In another aspect, the third width is more than twice the first width, and wherein the third width is more than twice the second width. In another aspect, each of the plurality of teeth includes a first portion and a second portion on a side of the first portion opposite the intermediate portion, and wherein the second portion is angled relative to the first portion. In another aspect, the second portion is angled 15 to 25 degrees relative to the first portion. In another aspect, each of the plurality of teeth includes a third portion on a side of the second portion opposite the first portion, the first portion defines a first planar surface, the third portion defines a third planar surface, and the first planar surface is parallel to the third planar surface. In another aspect, at least one of the plurality of teeth has a volume of at least 123 μL. In another aspect, at least one of the plurality of teeth has a volume of at least 50 μL. In another aspect, at least one of the plurality of teeth has a volume of at least 70 μL. In another aspect, each of the plurality of teeth has a volume of at least 70 μL. In another aspect, at least one of the plurality of teeth has a volume of at least 46 μL. In another aspect, each of the plurality of teeth has a volume of at least 46 μL. In another aspect, the first tooth has a volume of at least 50 μL, the second tooth has a volume of at least 50 μL, and the third tooth has a volume of at least 123 μL. In another aspect, the plurality of teeth is spaced apart from the third end by 1 to 5 millimeters, and wherein the plurality of teeth is spaced apart from the fourth end by 1 to 5 millimeters. In another aspect, the plurality of teeth is spaced apart from the third end by 6 to 10 millimeters, and wherein the plurality of teeth is spaced apart from the fourth end by 6 to 10 millimeters. In another aspect, the plurality of teeth is spaced apart from the third end by 11 to 15 millimeters, and wherein the plurality of teeth is spaced apart from the fourth end by 11 to 15 millimeters.

Another embodiment described herein is a comb for gel electrophoresis comprising: an elongated body including a first end and a second end; a wall extending at least partially around a periphery of the elongated body; an intermediate portion connected to the wall and extending between the first end and the second end of the elongated body, the intermediate portion having a third end and a fourth end opposite the third end, the third end adjacent the first end of the elongated body, the fourth end adjacent the second end of the elongated body; and a plurality of teeth extending from the intermediate portion between the third end and the fourth end, the plurality of teeth spaced apart from at least one of the third end and the fourth end. In one aspect, the plurality of teeth includes a first tooth nearest the third end of the intermediate portion, the first tooth has a first width, the first tooth is spaced apart from the third end of the intermediate portion by a first distance, and the first distance is greater than the first width. In another aspect, the plurality of teeth includes a second tooth nearest the fourth end of the intermediate portion, the second tooth has a second width, the second tooth is spaced apart from the fourth end of the intermediate portion by a second distance, and the second distance is greater than the second width. In another aspect, the first width is identical to the second width. In another aspect, the first distance is identical to the second distance. In another aspect, each tooth of the plurality of teeth has an identical width. In another aspect, the plurality of teeth includes a third tooth between the first tooth and the second tooth, the third tooth has a third width, and the third width is greater than the first width and the second width. In another aspect, the third width is more than twice the first width, and wherein the third width is more than twice the second width. In another aspect, each of the plurality of teeth includes a first portion and a second portion on a side of the first portion opposite the intermediate portion, and wherein the second portion is angled relative to the first portion. In another aspect, the second portion is angled 15 to 25 degrees relative to the first portion. In another aspect, each of the plurality of teeth includes a third portion on a side of the second portion opposite the first portion, the first portion defines a first planar surface, the third portion defines a third planar surface, and the first planar surface is parallel to the third planar surface. In another aspect, at least one of the plurality of teeth has a volume of at least 123 μL. In another aspect, at least one of the plurality of teeth has a volume of at least 50 μL. In another aspect, at least one of the plurality of teeth has a volume of at least 70 μL. In another aspect, each of the plurality of teeth has a volume of at least 70 μL. In another aspect, at least one of the plurality of teeth has a volume of at least 46 μL. In another aspect, each of the plurality of teeth has a volume of at least 46 μL. In another aspect, the first tooth has a volume of at least 50 μL, the second tooth has a volume of at least 50 μL, and the third tooth has a volume of at least 123 μL. In another aspect, the plurality of teeth is spaced apart from the third end by 1 to 5 millimeters, and wherein the plurality of teeth is spaced apart from the fourth end by 1 to 5 millimeters. In another aspect, the plurality of teeth is spaced apart from the third end by 6 to 10 millimeters, and wherein the plurality of teeth is spaced apart from the fourth end by 6 to 10 millimeters. In another aspect, the plurality of teeth is spaced apart from the third end by 11 to 15 millimeters, and wherein the plurality of teeth is spaced apart from the fourth end by 11 to 15 millimeters.

Another embodiment described herein is an assembly for gel electrophoresis comprising: a gel cassette configured to accommodate an electrophoresis gel casting solution, the gel cassette including a retainer plate and a divider plate coupled to form a cavity between the retainer plate and the divider plate, the retainer plate having an upper edge adjacent an opening to the cavity; and a comb including an elongated body having a first end, a second end opposite the first end, and a channel extending between the first end and the second end, a plurality of teeth extending from the elongated body between the first end and the second end, and a wall extending at least partially around a periphery of the elongated body, a portion of the wall configured to engage the upper edge of the retainer plate. In one aspect, the wall extends from a first side of the elongated body, and wherein the channel extends along a second side of the elongated body opposite the first side. In another aspect, the wall includes a rim extending between the first end and the second end and a lip extending between the first end and the second end, and wherein the rim engages the upper edge of the retainer plate. In another aspect, a recess is defined between the rim and the lip, and wherein the lip improves access to the elongated body to assist removal of the comb from the gel cassette. In another aspect, the elongated body includes a sloped surface in the recess and adjacent the rim, and wherein the electrophoresis gel casting solution is configured to flow along the sloped surface and off the comb. In another aspect, the sloped surface is angled at 30 degrees relative to elongated body. In another aspect, the sloped surface is positioned on a side of the elongated body opposite the channel. In another aspect, the retainer plate includes: a retainer body, an abutment portion extending along the retainer body adjacent the opening, the abutment portion having the upper edge, the abutment portion having tapered edges, and a rail extending along the retainer body, the rail spaced apart from the abutment portion, the rail having tapered edges. In another aspect, the comb includes an intermediate portion between the elongated body and the plurality of teeth, the intermediate portion extends between the first end and the second end of the elongated body, the intermediate portion has a third end and a fourth end opposite the third end, and the third and the fourth ends engage an internal edge of the cavity. In another aspect, the channel extends past the third end and the fourth end. In another aspect, the plurality of teeth is spaced apart from at least one of the third end and the fourth end. In another aspect, the assembly further comprises polymerized electrophoresis gel casting solution comprising polyacrylamide, one or more buffers, and optionally a detergent.

Another embodiment described herein is comb for gel electrophoresis comprising: an elongated body including: a first end, a second end opposite the first end, and a channel extending between the first end and the second end; a wall extending at least partially around a periphery of the elongated body, the wall including a rim extending between the first end and the second end and a lip extending between the first end and the second end; and a plurality of teeth extending from the elongated body between the first end and the second end. In one aspect, the wall extends from a first side of the elongated body, and wherein the channel extends along a second side of the elongated body opposite the first side. In another aspect, a recess is defined between the rim and the lip, and wherein the lip improves access to the elongated body. In another aspect, the elongated body includes a sloped surface in the recess and adjacent the rim, and wherein an electrophoresis gel casting solution is configured to flow along the sloped surface and off the comb. In another aspect, the sloped surface is angled at 30 degrees relative to the elongated body. In another aspect, the sloped surface is positioned on a side of the elongated body opposite the channel. In another aspect, the comb includes an intermediate portion between the elongated body and the plurality of teeth, the intermediate portion extends between the first end and the second end of the elongated body, and the intermediate portion has a third end and a fourth end opposite the third end. In another aspect, the channel extends past the third end and the fourth end. In another aspect, the plurality of teeth is spaced apart from at least one of the third end and the fourth end.

Another embodiment described herein is an assembly for gel electrophoresis comprising: a gel cassette comprising a retainer plate and a divider plate coupled to form a cavity between the retainer plate and the divider plate, the retainer plate having an upper edge adjacent an opening to the cavity; and a comb including an elongated body having a first end and a second end opposite the first end, and a wall extending at least partially around a periphery of the elongated body, the wall including a rim extending between the first end and the second end, the rim in contact with the upper edge of the retainer plate, and a plurality of teeth extending from the wall between the first end and the second end of the elongated body. In one aspect, the elongated body includes a channel extending between the first end and the second end. In another aspect, the wall extends from a first side of the elongated body, and wherein the channel extends along a second side of the elongated body opposite the first side. In another aspect, each of the plurality of teeth includes a first portion and a second portion on a side of the first portion opposite the wall, and wherein the second portion is angled relative to the first portion. In another aspect, the second portion is angled 15 to 25 degrees relative to the first portion. In another aspect, each of the plurality of teeth includes a third portion on a side of the second portion opposite the first portion, the first portion defines a first planar surface, the third portion defines a third planar surface, and the first planar surface is parallel to the third planar surface. In another aspect, at least one of the plurality of teeth has a volume of at least 123 μL. In another aspect, at least one of the plurality of teeth has a volume of at least 50 μL. In another aspect, at least one of the plurality of teeth has a volume of at least 70 μL. In another aspect, each of the plurality of teeth has a volume of at least 70 μL. In another aspect, at least one of the plurality of teeth has a volume of at least 46 μL. In another aspect, each of the plurality of teeth has a volume of at least 46 μL.

Another embodiment described herein is a comb for gel electrophoresis, the comb configured to be received in a cassette including an upper edge, the comb comprising: an elongated body including a first end and a second end; a wall extending at least partially around a periphery of the elongated body, the wall including a rim extending between the first end and the second end, the rim configured to engage the upper edge of the cassette; an intermediate portion connected to the wall and extending between the first end and the second end of the elongated body; and a plurality of teeth extending from the intermediate portion. In another aspect, the elongated body includes a channel extending between the first end and the second end. In another aspect, the wall extends from a first side of the elongated body, and wherein the channel extends along a second side of the elongated body opposite the first side. In another aspect, each of the plurality of teeth includes a first portion and a second portion on a side of the first portion opposite the intermediate portion, and wherein the second portion is angled relative to the first portion. In another aspect, the second portion is angled 15 to 25 degrees relative to the first portion. In another aspect, each of the plurality of teeth includes a third portion on a side of the second portion opposite the first portion, the first portion defines a first planar surface, the third portion defines a third planar surface, and the first planar surface is parallel to the third planar surface. In another aspect, at least one of the plurality of teeth has a volume of at least 123 μL. In another aspect, at least one of the plurality of teeth has a volume of at least 50 μL. In another aspect, at least one of the plurality of teeth has a volume of at least 70 μL. In another aspect, each of the plurality of teeth has a volume of at least 70 μL. In another aspect, at least one of the plurality of teeth has a volume of at least 46 μL. In another aspect, each of the plurality of teeth has a volume of at least 46 μL.

Another embodiment described herein is a kit comprising: an assembly described herein, polymerized electrophoresis gel casting solution comprising polyacrylamide, one or more buffers, and optionally a detergent; packaging comprising bags, pouches, plastic containers, or boxes; buffer solution; and optionally, instructions for use.

Another embodiment described herein is a method for efficiently loading one or more large-volume samples in an electrophoretic gel, the method comprising: providing an assembly described herein; removing the comb from the assembly; and loading one or more samples into one or more wells.

Another embodiment described herein is a method for running multiple samples on an electrophoretic gel without band shape distortion in the samples proximate to the gel edges, the method comprising: providing an assembly described herein; removing the comb from the assembly; introducing one or more samples into one or more wells; and applying an electric current to induce electrophoresis.

Another embodiment described herein is a method for casting and loading an electrophoretic gel without excess polymerized gel casting solution contaminating at least one well formed in the polymerized gel in a cassette, the method comprising: providing an assembly described herein; introducing a sufficient amount of electrophoresis gel casting solution to fill the cassette, wherein the electrophoresis gel casting solution comprises polyacrylamide, one or more buffers, and optionally a detergent, and wherein polymerization of the electrophoresis gel casting solution has been initiated by an addition of a polymerization initiator and optionally a polymerization accelerator; inserting a comb described herein into the cassette; permitting the electrophoresis gel casting solution to polymerize for a period of time; removing the comb from the cassette, wherein up on removal minimal excess polymerized gel casting solution exists in or surrounding one or more wells; and loading one or more samples into one or more wells.

Another embodiment described herein is a method for detecting low abundant-proteins or proteins in dilute samples by loading large sample volumes: providing an assembly described herein; removing the comb from the assembly; introducing one or more samples into one or more wells, wherein the wells comprise volumes of 40-100 μL; and applying an electric current to induce electrophoresis.

Another embodiment described herein is the use of an assembly described herein for performing electrophoresis of a sample. In one aspect, the sample is a low abundant-protein or proteins in dilute samples.

Another embodiment described herein is the use of a comb described herein for casting an electrophoretic gel, wherein wells created by the comb have volumes of about 40-100 μL.

Another embodiment described herein is an assembly for gel electrophoresis comprising: a gel cassette comprising a retainer plate and a divider plate coupled to form a cavity between the retainer plate and the divider plate; and comb comprising an elongated body having a first end and a second end, an intermediate portion connected to the elongated body and extending between the first end and the second end, the intermediate portion having a third end adjacent the first end of the elongated body and a fourth end adjacent the second end of the elongated body, and a plurality of teeth extending from the intermediate portion between the first end and the second end, the plurality of teeth spaced apart from at least one of the third end and the fourth end, wherein the comb is configured to be received in the gel cassette, and wherein in response to the comb being received in the gel cassette, the intermediate portion is received in the cavity such that the third and the fourth ends are configured to engage an internal edge of the cavity. In another aspect, the plurality of teeth includes a first tooth nearest the third end of the intermediate portion, the first tooth has a first width, the first tooth is spaced apart from the third end of the intermediate portion by a first distance, and the first distance is greater than the first width. In another aspect, the plurality of teeth includes a second tooth nearest the fourth end of the intermediate portion, the second tooth has a second width, the second tooth is spaced apart from the fourth end of the intermediate portion by a second distance, and the second distance is greater than the second width. In another aspect, the first width is identical to the second width, and wherein the first distance is identical to the second distance. In another aspect, the plurality of teeth includes a third tooth between the first tooth and the second tooth, the third tooth has a third width, and the third width is greater than the first width and/or the second width. In another aspect, each tooth of the plurality of teeth has an identical width.

Another embodiment described herein is an assembly for gel electrophoresis comprising: a gel cassette configured to accommodate an electrophoresis gel casting solution, the gel cassette including a retainer plate and a divider plate coupled to form a cavity between the retainer plate and the divider plate, the retainer plate having an upper edge adjacent an opening to the cavity; and a comb including an elongated body having a first end, a second end opposite the first end, and a channel extending between the first end and the second end, a plurality of teeth extending from the elongated body between the first end and the second end, and a wall extending at least partially around a periphery of the elongated body, wherein the comb is configured to be received in the gel cassette, and wherein in response to the comb being received in the gel cassette, a portion of the wall is configured to engage the upper edge of the retainer plate. In another aspect, the wall extends from a first side of the elongated body, and wherein the channel extends along a second side of the elongated body opposite the first side. In another aspect, the wall includes a rim extending between the first end and the second end and a lip extending between the first end and the second end, and wherein in response to the comb being received in the gel cassette, the rim is configured to engage the upper edge of the retainer plate. In another aspect, a recess is defined between the rim and the lip, and wherein the lip improves access to the elongated body to assist removal of the comb from the gel cassette. In another aspect, the elongated body includes a sloped surface in the recess and adjacent the rim, and wherein the electrophoresis gel casting solution is configured to flow along the sloped surface and off the comb, and wherein the sloped surface is positioned on a side of the elongated body opposite the channel. In another aspect, the retainer plate includes: a retainer body, an abutment portion extending along the retainer body adjacent the opening, the abutment portion having the upper edge, the abutment portion having tapered edges, and a rail extending along the retainer body, the rail spaced apart from the abutment portion, the rail having tapered edges. In another aspect, the comb includes an intermediate portion between the elongated body and the plurality of teeth, the intermediate portion extends between the first end and the second end of the elongated body, the intermediate portion has a third end and a fourth end opposite the third end, and in response to the comb being received in the gel cassette, the third and the fourth ends are configured to engage an internal edge of the cavity.

### DESCRIPTION OF THE DRAWINGS

FIG. 1 shows a perspective view of a comb received in a gel cassette.

FIG. 2 shows a side view of the comb and the gel cassette of FIG. 1.

FIG. 3 shows an exploded view of the comb and the gel cassette of FIG. 1.

FIG. 4 shows another exploded view of the comb and the gel cassette of FIG. 1.

FIG. 5 shows a perspective view of the comb of FIG. 1.

FIG. 6 shows another perspective view of the comb of FIG. 1.

FIG. 7 shows a side view of the comb of FIG. 1.

FIG. 8 shows another side view of the comb of FIG. 1.

FIG. 9 shows an enlarged view of a portion of the comb as identified in FIG. 7.

FIG. 10 shows a cross-sectional view of the comb and the gel cassette taken along line 10-10 in FIG. 2.

FIG. 11 shows an enlarged view of a portion of the comb and the gel cassette as identified in FIG. 10.

FIG. 12 shows a perspective view of another comb that can be received in the gel cassette of FIG. 1.

FIG. 13 shows another perspective view of the comb of FIG. 12.

FIG. 14 shows a side view of the comb of FIG. 12.

FIG. 15 shows another side view of the comb of FIG. 12.

FIG. 16 shows a perspective view of another comb that can be received in the gel cassette of FIG. 1.

FIG. 17 shows another perspective view of the comb of FIG. 16.

FIG. 18 shows a side view of the comb of FIG. 16.

FIG. 19 shows another side view of the comb of FIG. 16.

### DETAILED DESCRIPTION

Unless otherwise defined, all technical and scientific terms used herein have the same meaning as commonly understood by one of ordinary skill in the art. For example, any nomenclatures used in connection with, and techniques of electrophoresis, biochemistry, molecular biology, or protein and nucleic acid chemistry described herein are well known and commonly used in the art. In case of conflict, the present disclosure, including definitions, will control. Exemplary methods and materials are described below, although methods and materials similar or equivalent to those described herein can be used in practice or testing of the embodiments and aspects described herein.

As used herein, terms such as “include,” “including,” “contain,” “containing,” “having,” and the like mean “comprising.” The present disclosure also contemplates other embodiments “comprising,” “consisting essentially of,” and “consisting of” the embodiments or elements presented herein, whether explicitly set forth or not. As used herein, “comprising,” is an “open-ended”term that does not exclude additional, unrecited elements or method steps. As used herein, “consisting essentially of” limits the scope of a claim to the specified materials or steps and those that do not materially affect the basic and novel characteristics of the claimed invention. As used herein, “consisting of” excludes any element, step, or ingredient not specified in the claim.

As used herein, the term “a,” “an,” “the” and similar terms used in the context of the disclosure (especially in the context of the claims) are to be construed to cover both the singular and plural unless otherwise indicated herein or clearly contradicted by the context. In addition, “a,” “an,” or “the” means “one or more” unless otherwise specified.

As used herein, the term “or” can be conjunctive or disjunctive.

As used herein, the term “and/or” refers to both the conjunctive and disjunctive.

As used herein, the term “substantially” means to a great or significant extent, but not completely.

As used herein, the term “about” or “approximately” as applied to one or more values of interest, refers to a value that is similar to a stated reference value, or within an acceptable error range for the particular value as determined by one of ordinary skill in the art, which will depend in part on how the value is measured or determined, such as the limitations of the measurement system. In one aspect, the term “about” refers to any values, including both integers and fractional components that are within a variation of up to ±10% of the value modified by the term “about.” Alternatively, “about” can mean within 3 or more standard deviations, per the practice in the art. Alternatively, such as with respect to biological systems or processes, the term “about” can mean within an order of magnitude, in some embodiments within 5-fold, and in some embodiments within 2-fold, of a value. As used herein, the symbol “˜” means “about” or “approximately.”

All ranges disclosed herein include both end points as discrete values as well as all integers and fractions specified within the range. For example, a range of 0.1-2.0 includes 0.1, 0.2, 0.3, 0.4 . . . 2.0. If the end points are modified by the term “about,” the range specified is expanded by a variation of up to ±10% of any value within the range or within 3 or more standard deviations, including the end points, or as described above in the definition of “about.”

As used herein, the terms “room temperature,” “RT,” or “ambient temperature” refer to the typical temperature in an indoor laboratory setting. In one aspect, the laboratory setting is climate controlled to maintain the temperature at a substantially uniform temperature or with a specific range of temperatures. In one aspect, “room temperature” refers a temperature of about 15-30° C., including all integers and endpoints within the specified range. In another aspect, “room temperature” refers a temperature of about 15-30° C.; about 20-30° C.; about 22-30° C.; about 25-30° C.; about 27-30° C.; about 15-22° C.; about 15-25° C.; about 15-27° C.; about 20-22° C.; about 20-25° C.; about 20-27° C.; about 22-25° C.; about 22-27° C.; about 25-27° C.; about 15° C.±10%; about 20° C.±10%; about 22° C.±10%; about 25° C.±10%; about 27° C.±10%; ˜20° C., ˜22° C., ˜25° C., or ˜27° C., at standard atmospheric pressure.

As used herein, the terms “control,” or “reference” are used herein interchangeably. A “reference” or “control” level may be a predetermined value or range, which is employed as a baseline or benchmark against which to assess a measured result. “Control” also refers to control experiments.

As used herein, “PAGE” refers to polyacrylamide gel electrophoresis. “SDS-PAGE” refers to sodium docecyl sulfate (“SDS”) polyacrylamide gel electrophoresis.

As used herein “polyacrylamide” refers to a mixture of acrylamide (CH₂═CHC(O)NH₂) and bisacrylamide (CH₂[NHC(O)CH═CH₂]₂). The percentage of polyacrylamide in the gel casting solution determines the gel porosity, with typical percentages ranging from 5-25%. The molecular weight of the biomolecule determiners the percentage of the gel, with greater molecular weights requiring lower percentage gels for optimal resolution.

An “electrophoresis gel casting solution” as described herein refers to the solution used to cast an electrophoretic gel. The solution contains a percentage of polyacrylamide, a buffer, and water. For SDS-PAGE, the electrophoresis gel casting solution typically contains 8-12.5% polyacrylamide, Tris-glycine buffer, and sodium docecyl sulfate (“SDS”). The solution is cast by adding a polymerization initiator, such as the oxidizing agent ammonium persulfate (APS). Often a polymerization accelerator such as tetramethylethylenediamine (TEMED) is added to facilitate rapid polymerization. Upon adding the polymerization initiator, the gel polymerizes within 10-30 min.

As used herein a “stacking gel” refers to an electrophoretic gel that comprises at least two layers—an upper gel having a lower pH and lower percentage of polyacrylamide, and a lower gel, or “resolving gel” that has a greater pH and higher percentage of polyacrylamide. The stacking gel permits the sample volume in the well to be concentrated so that the entire sample enters the resolving gel in a focused, narrow band.

As used herein a “running buffer” refers to the buffer present at the positive and negative terminals of the gel. Typical SDS-PAGE running buffer (1× concentration) consists of 25 mM Tris hydroxy amino methane (Tris), 192 mM glycine, pH 8.3, and 0.1% sodium docecyl sulfate.

An “electrophoretic gel running apparatus” as described herein refers to an assembly comprising at least one electrophoretic gel assembly, a negative terminal, a positive terminal a buffer reservoir at the positive and negative terminals, and a power supply for providing electric current. Typical electrophoretic gels are run with the negative terminal proximate to the wells (top) and the positive terminal proximate to the opposite side (bottom). The electrophoretic gel assembly comprises a gel cassette as described herein and a polyacrylamide gel.

Described herein is an apparatus for gel electrophoresis comprising a gel cassette and a comb having at least one tooth. The gel cassette may include a retainer plate and a divider plate. The plates may be formed by a process such as injection molding. Any suitable plastic may be used for forming the plates, such as for example purposes only polymers such as polyethylene terephthalate, polyvinyl chloride, polymethyl methacrylate, polystyrene, polyethylene, polymethyl polypropylene, and cellulose acetates or various co-polymers. In some embodiments, the plastic may be a transparent plastic so that the gel may be viewed inside the assembled cassette. In some embodiments, the cassette may be constructed from glass plates, or may be constructed from one glass plate and one plastic plate. In some embodiments, the device may be configured to create precast gels that lay flat on various surfaces. The ability to create precast gels that lay flat may be beneficial for product shipping and storage, as well as during routine handling by the user. Additionally, the gel cassette may lay flat in auto-loading machinery during gel manufacturing.

In some embodiments, the divider plate has a series of features, bumps, or posts located along the length of either the sides of the plate, along the bottom length of the plate or both along the sides and bottom of the plate. The posts may function as energy directors during the assembly process to create a uniform seal around the plate. In some embodiments, a slot may be located at the bottom portion of the divider plate, and in some embodiments, may or may not extend through the thickness of the plate. The slot may expose the gel inside the cassette to a buffer, such as an anode buffer, to complete or assist in completing an electrical path circuit during electrophoresis. During formation of the gel, the slot may be sealed with a sealant, such as tape, epoxy, polymers, conductive polymers, or any other suitable sealant to prevent the gel material from escaping the assembled cassette prior to setting of the gel. In some embodiments, the divider plate may include a ridge that together with the spacer on the retainer plate creates the gel cavity. In some embodiments, the sealant may be present on the divider plate prior to assembling of the cassette, or the sealant may be placed over the slot on the assembled cassette by the user prior to filling the assembled cassette with a gel material. After the gel has been formed, the sealant may be removed if a non-conductive sealant is used, so to expose the gel to a buffer to complete or assist in completing an electrical path circuit. At the top of the divider plate, the top surface may include a grip or a curved surface to facilitate handling of the assembled cassette. In some embodiments, at least one of the plates, for example, the retainer plate may have a spacer located on its interior surface. The spacer may be any suitable shaped spacer, for example, a generally u-shaped raised spacer located on the interior surface. In some embodiments, the spacer may be located on the interior surface of one plate and contact the interior surface of the other plate. In some embodiments, a spacer may be located on the interior surface of both plates and the two spacers may contact each other when the cassette is formed. The spacer or spacers may further serve to help maintain the space between the divider plate and the retainer plate when the plates are joined to form a cassette. When the retainer plate and the divider plate are joined together, the interior surfaces of the plates form a slab shaped cavity which may be sealed by the raised spacer. In some embodiments, the ridge located on the divider forms the seal between the divider plate and the retainer plate. In some embodiments, both the spacer and the ridge seal the gel cavity. In some embodiments, the retainer plate and the divider plate may be fabricated as a single piece of plastic. In some embodiments, the retainer plate and the divider plate may be two separate parts that are connected together. The two separate parts may be connected together by any suitable mechanism for attaching the plates together including, for example purposes only, glue, pressure fitting, welding, adhesive, clamps, clips, or any other suitable mechanism. The thickness of the cavity may be determined by the height of the spacer. In some embodiments, the cavity formed by the divider plate and the retainer plate is capable of holding gel material that may form a gel about 1 mm thick.

In some embodiments, an abutment portion extends at some angle away from the exterior surface of one of the plates to form an opening. Gel material may enter into the cassette through the opening. Additionally, a structure for forming sample wells in the gel may be introduced to the gel material through the opening. In some embodiments, the abutment portion may extend from the exterior surface of one of the plates at an angle, for example at about a 70° angle from a plane perpendicular to the exterior surface of the plate, or 20° from surface of the plate. In some embodiments, the angle may be between about 15° and about 25°, between about 10° and 30°, between about 5° and 35°, including all integers within the specified ranges, or any other suitable angle. In some embodiments, the abutment portion may extend from the exterior surface of the plate by less than about 45°. In some embodiments, the projections may facilitate stacking the welded cassettes in a magazine, aiding in the manufacturing process. In some embodiments, an assembled cassette may have at least one abutment portion on at least one side to create an opening that may be able to accommodate a comb for creating wells in the gel where the comb is wedge-shaped or has a wedge-shaped portion or has at least one angled portion, such as any of the combs described herein. In some embodiments, an abutment portion may be located on both sides of the opening, creating a v-shaped opening to accommodate v-shaped teeth on a comb. In some embodiments, the opening of the cassette may have an opening that is flat on both sides but is wide enough to accommodate wedge shaped or v-shaped teeth on a comb without the need for an abutment portion extending from one of the surfaces of the plate.

In some embodiments of the device, the cassette has at least one interior surface which may be coated with a coating. The coating may be an oxygen interference coating (a coating that forms an oxygen barrier that reduces diffusion from the surface of the plastic plates into the gel to prevent significant local variations in the rate of oxygen diffusion) such as, for example purposes only, a coating comprising SiOₓ, SiO, or SiO₂. In some embodiments the coating may be substantially transparent. The interior surfaces may be coated manually or mechanically and, in some embodiments, where two separate plates are formed into the cassette, the coating may be performed before or after joining the plates into the cassette. In some embodiments, the interior surfaces of the cassette may be coated under vacuum using evaporation or vapor deposition, sputter deposition, chemical vapor deposition, plasma-enhanced chemical vapor deposition, or any combination thereof. In some embodiments, the coating deposited may be of a thickness less than about 5000 Å in thickness.

Provided herein is an apparatus for gel electrophoresis comprising a comb having teeth configured to create sample wells configured to receive at least 10% more sample than a standard gel sample well. Increased sample size may allow for more sample to be loaded into the gel without causing damage to the gel and yet still produce sharp, high resolution bands. Additionally, a large sample well opening may facilitate loading samples with standard pipette tips instead of special drawn-out gel loading pipette tips.

Once the gel material for forming a gel has been poured into the opening of an assembled cassette, a comb may be inserted into the opening of the assembled cassette and into the gel material. The depth of insertion of the comb may be limited by the edges of the comb and the shoulders of the opening located on the cassette. In some embodiments, the depth of insertion of the comb may be further limited by the comb resting on the front edge of the abutment portion. Once the gel has been cast, the comb may then be removed leaving a void in the gel at the position of each tooth. Each void forms a sample well having a sample volume.

In some embodiments, the comb may have teeth that comprise an angled surface. In some embodiments, the comb may have teeth that comprise a wedge-shaped portion. In some embodiments, the comb may have wedge-shaped teeth. A comb having teeth with an angled surface, teeth with a wedge-shaped portion, or wedge-shaped teeth may be capable of creating wedge-shaped wells in the gel. In some embodiments, the wedge-shaped teeth have flat surfaces at the tips of the teeth. The flat bottom surface of the teeth creates sample wells having flat bottoms. The flat bottom of the sample well becomes the leading edge of the stacked sample bands which may ultimately resolve into bands that are as flat and similar to bands created by standard combs. The wells created by insertion of the comb with teeth with an angled surface, teeth with a wedge-shaped portion, or wedge-shaped teeth into the gel material may provide a larger opening to the well at the top of the sample well and thereby create easier access to the wells using a standard pipette tip on a single pipette or on a multi-channel pipette. Additionally, the wells permit a greater amount of sample to be loaded into a thinner gel (for example, approximately 1 mm thick gels). In some embodiments, the wells may be wedge-shaped or comprise a wedge-shape. The comb may be used with any of the cassettes described herein previously or may be used with any other suitable cassette for creating a gel.

The wells in the gel created by the teeth with an angled surface, teeth with a wedge-shaped portion, or wedge-shaped teeth may be of a volume at least 12% greater than the volume of the wells created using a standard comb. In some embodiments, a standard comb may create wells having a volume of about 41 μL. In some embodiments, the wells may have a volume that is at least 10-200% greater, including all integers within the specified range; at least 20% greater, at least 50% greater, at least 100% greater, at least 150% greater, at least 175% greater, at least 200% greater, at least 250% greater than a well created using a standard comb. In some embodiments, the sample well size created by combs described herein may be at least 46 μL. In some embodiments, the sample well size created by the comb described herein may be about 40-200 μL including all integers and subranges within the specified range. In some embodiments, the sample well size created by the comb described herein may be at least about 50 μL, at least about 70 μL, at least 123 μL.

Additionally, sample wells formed by the combs described herein may allow for loading an increased amount of sample while maintaining or improving band sharpness and resolution during electrophoresis while reducing edge effects. The wells formed by the teeth with an angled surface, teeth with a wedge-shaped portion, or teeth of a wedge-tooth comb allows more sample to be loaded into a well, while keeping the sample away from the sides of the gel. Sample that is located toward the ends of the gel may not form as sharp bands or bands having high resolution. Positioning of the wells at such locations reduces the chance that the bands formed in the gel will turn up at the ends of the band or “smile” or turn down at the edges of the band or “frown.” Additionally, sample wells having a wedge-shape or comprising a wedge-shape created using the apparatus described herein have a greater cross sectional area at the top of the sample well as compared to the bottom of the sample well. The increase in cross sectional area creates a lower voltage drop at any given constant voltage, current or wattage at the top of the sample well compared to the bottom of the sample well. The lower voltage drop, or field strength, in this area may lead to better sample stacking than in the thinner sections of the well and/or gel, or in gels with wells of the same thickness throughout the sample loading volume.

In some embodiments, the gel cassettes are about 10 cm by 10 cm for midi-gel cassettes. The gels housed in the gel cassettes are about 7 cm in length (the running length) by about 8 cm wide. The gel cassettes and gels run in the gel cassettes may be any suitable length. In some embodiments, the gel cassette width may be large enough to reduce edge effects in gels having at least 10-12 wells. In some embodiments, the assembled cassette may include a gap that runs around the outer perimeter of the cassette. The gap may facilitate the opening of the cassette for gel retrieval. In some embodiments, the gel cassette may be opened with a gel knife or may be opened by hand.

In some embodiments, the comb may be a twelve-tooth comb, that is, a comb used for forming 12 sample wells in a gel. In one aspect, the comb additional contains a smaller tooth at each terminus (two smaller teeth in total) for control samples or marker samples. In another aspect, the comb teeth are inset an increased distance from the edge which results in better sample run quality and resolution for the lanes proximate to the edges of the gel. In some embodiments, the comb may be at least a single tooth comb, at least a 2-tooth comb, at least a 3-tooth comb, at least a 4-tooth comb, at least a 5-tooth comb, at least a 6-tooth comb, at least a 7-tooth comb, at least a 8-tooth comb, at least a 9-tooth comb, at least a 10-tooth comb, at least a 11-tooth comb, at least a 12-tooth comb, at least a 14-tooth comb, at least a 15-tooth comb, at least a 16-tooth comb, at least a 17-tooth comb, at least a 18-tooth comb, at least a 20-tooth comb, at least a 22-tooth comb, at least a 24-tooth comb, at least a 26-tooth comb, at least a 28-tooth comb, at least a 30-tooth comb, or any other comb having a suitable number of teeth; in each of the foregoing aspects, the comb may also have at least 2 terminal teeth of smaller dimensions compared to the specified teeth for control or marker samples. In some embodiments, the comb may be molded from any suitable plastic including, but not limited to polymers such as polyethylene terephthalate, polyvinyl chloride, polymethyl methacrylate, polystyrene, polyethylene, polymethyl polypropylene, cellulose acetates, co-polymers, polycarbonate, or any other suitable material. In some embodiments, the dimensions of the teeth may be uniform along the length of the comb, or the teeth may have varying dimensions along the length of the comb. The teeth may or may not be the same shape as the wedge shaped opening of the cassette.

In some embodiments, the edge of the comb opposite to the teeth may serve as a handle that may facilitate the insertion and removal of the comb from the cassette. In some embodiments, the edge may be curved. The comb may further include a back surface and a front surface. In some embodiments, the front and back surfaces are solid. In some embodiments, the front surface of the comb has a recessed space which facilitates gripping the comb by the user to facilitate the insertion of the comb into the cassette as well as to remove the comb from the cassette once the gel and wells have been formed.

### Cassette

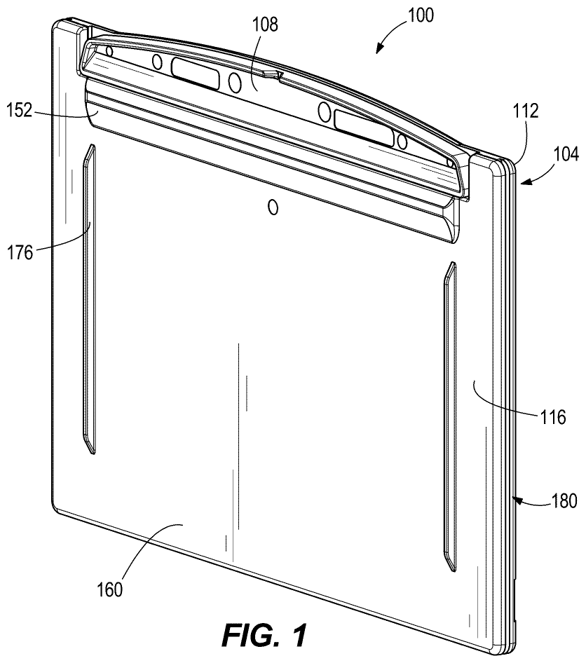

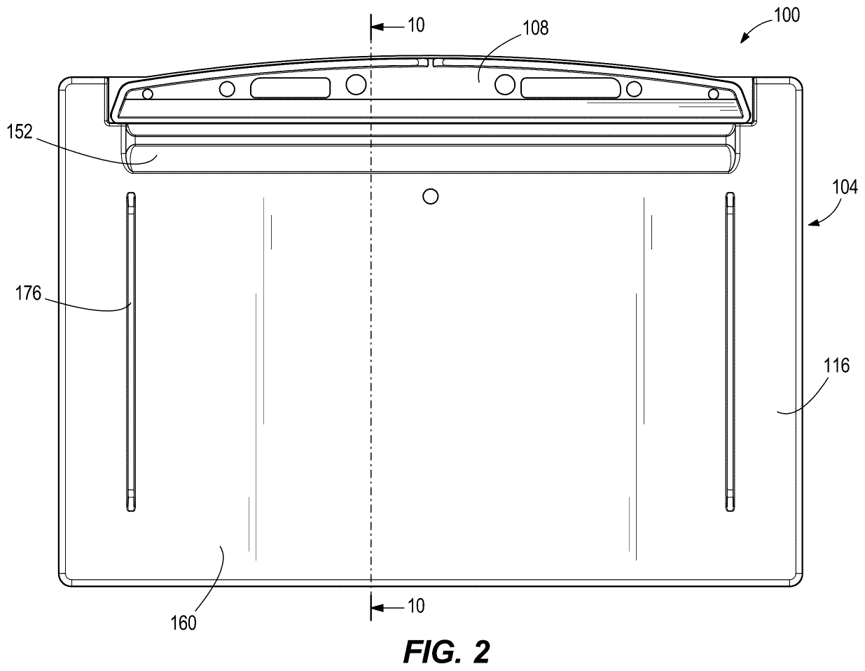

FIGS. 1 and 2 illustrate an embodiment of a gel electrophoresis assembly 100 (also referred to as an assembly 100). The gel electrophoresis assembly 100 includes a gel cassette 104 (also referred to as an assembled cassette 104) and a comb 108. The gel cassette 104 includes a divider plate 112 and a retainer plate 116 (also referred to as a retaining plate 116). The divider and retainer plates 112, 116 may be formed by a process such as injection molding. Any suitable plastic may be used for forming the divider and retaining plates 112, 116. Suitable plastics for forming electrophoresis gel molds include polymers such as polyethylene terephthalate, polyvinyl chloride, polymethyl methacrylate, polystyrene, polyethylene, polymethyl polypropylene, and cellulose acetates or various co-polymers. In some embodiments, the plastic may be a transparent plastic so that the gel may be viewed inside the assembled cassette 104. In some embodiments, the cassette 104 may be constructed from glass plates, or may be constructed from one glass plate and one plastic plate.

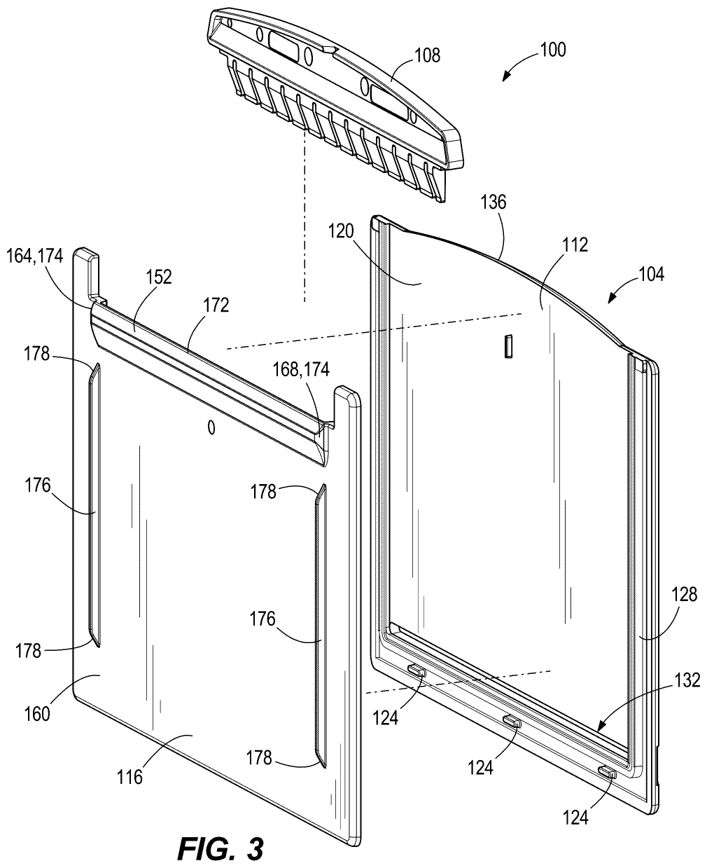

With reference to FIG. 3, the divider plate 112 includes an interior surface 120. The divider plate 112 can include a series of features, bumps, or posts 124 located along a bottom length of the divider plate 112 and/or along a length of the sides of the divider plate 112. The posts 124 may protrude from the divider plate 112 and connect with the retainer plate 116. The divider plate 112 may additionally include a ridge 128 that runs down the sides and across the bottom of the divider plate 112. The ridge 128 may be used to seal the gel cavity on the assembled cassette 104. In some embodiments, a slot 132 may be located at the bottom portion of the divider plate 112. In some embodiments, the slot 132 may or may not extend through the thickness of the divider plate 112. The slot 132 may expose the gel inside the cassette 104 to a buffer, such as an anode buffer, to complete, or assist in completing, an electrical path circuit during electrophoresis. A top surface 136 of the divider plate 112 may include a grip or a curved surface to, for example, facilitate handling of the assembled cassette 104.

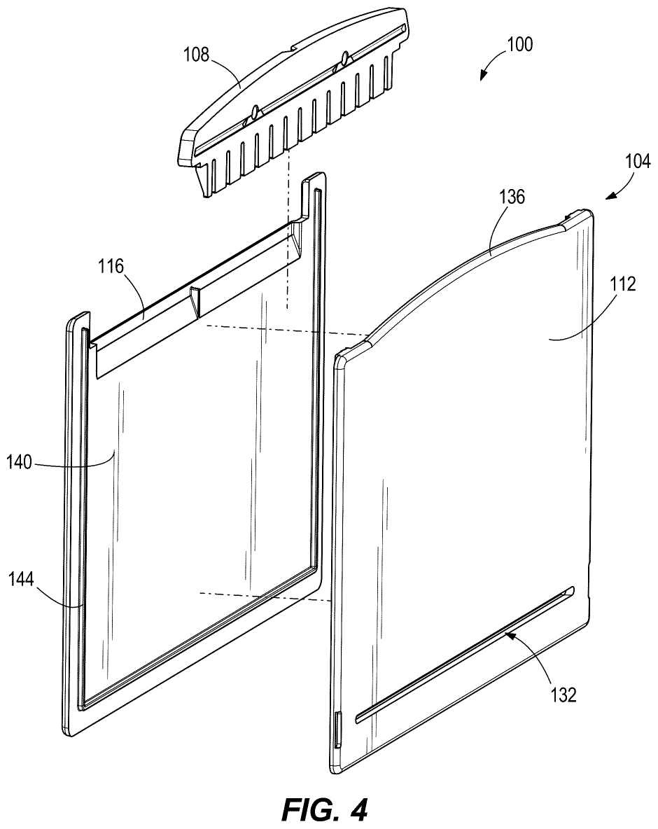

With reference to FIG. 4, the retainer plate 116 includes an interior surface 140. In some embodiments, the retainer plate 116 may have a generally u-shaped raised spacer 144 located on the interior surface 140 which may contact the divider plate 112. The spacer 144 can, for example, be received between the posts 124 and the ridge 128 of the divider plate 112 (shown in FIG. 3) to couple the retainer plate 116 to the divider plate 112. The u-shaped spacer 144 can further define the spacing between, or to maintain the space between, the retainer plate 116 and the divider plate 112 when the plates are joined to form the cassette 104. In response to the divider plate 112 and the retainer plate 116 being joined together, the interior surfaces 120, 140 of the plates 112, 116 form a slab shaped cavity 148 (shown in FIG. 11) which may be bounded by the raised spacer 144. During assembly, either the spacer 144, the ridge 128 on the divider plate 112 (shown in FIG. 3), or the spacer 144 and ridge 128 can seal the cavity 148. The thickness of the cavity 148 is determined by the height of the u-shaped spacer 144. The cavity 148 formed by the divider plate 112 and the retainer plate 116 is capable of containing and confining gel material that may, for example, form a gel 1 mm thick.

With reference back to FIG. 3, the retainer plate 116 includes an abutment portion 152 extending at an angle away from the retainer plate 116 to form an opening 156 (shown in FIG. 11) to the cavity 148. The abutment portion 152 extends from an exterior surface 160 of the retainer plate 116 in a direction away from the divider plate 112 to form the opening 156. The abutment portion 152 includes a first shoulder 164, a second shoulder 168 opposite the first shoulder 164, and a front edge 172 (also referred to as an upper edge 172) positioned therebetween. Each of the first shoulder 164 and the second shoulder 168 includes a tapered edge 174. The tapered edges 174 of the abutment portion 152 are configured to assist with limiting the abutment portion 152 from damaging an associated storage vessel. For example, the tapered edges 174 reduces the risk of the abutment portion 152 ripping or tearing a bag or pouch (not shown) within which the cassette 104 is stored. The tapered edges 174 can be chamfered, curved, rounded, or have any other suitable shape to inhibit ripping, tearing, or otherwise rupturing the storage bag or pouch surrounding the cassette 104. In some embodiments, an assembled cassette 104 may have at least one abutment portion 152 on at least one side to create the opening 156 to accommodate the comb 108 for creating wells in the gel. In some embodiments, the divider plate 112 may also include an abutment portion 152, such that the opening 156 is v-shaped.

With continued reference to FIG. 3, the retainer plate 116 can include rails 176 on the exterior surface 160 of the retainer plate 116. The rails 176 can extend in a direction oblique to the direction of the front edge 172. The rails 176 can, for example, facilitate stacking of the cassettes 104 in a magazine, aiding in the manufacturing process. Each rail 176 includes tapered rail edges 178. The tapered rail edges 178 are configured to reduce the risk of the rails 176 ripping or tearing the bag or pouch (not shown) within which the cassette 104 is stored. The tapered rail edges 178 can be chamfered, curved, rounded, or have any other suitable shape to inhibit ripping, tearing, or otherwise rupturing the storage bag or pouch surrounding the cassette 104.

In some embodiments, the retainer plate 116 and the divider plate 112 may be fabricated as a single piece of plastic. In some embodiments, the retainer plate 116 and the divider plate 112 may be two separate parts that are connected together. The two separate parts may be connected together by any suitable mechanism for attaching the plates together including, for example purposes only, glue, pressure fitting, welding, adhesive, tapes, clamps, clips, or any other suitable mechanism.

During preparation of a gel, the slot 132 in the divider plate 112 may be sealed. The slot 132 may be sealed by any suitable sealant (or sealing assembly), including tape, epoxy, glue, polymer compound, or any other suitable sealant. The sealant may or may not be a conductive sealant. In some embodiments, the sealant may be a permanent sealant or a removable sealant. Once the slot 132 has been sealed, the cassette 104 can be oriented vertically and gel-forming mixture (also referred to as an electrophoresis gel casting solution) is poured through the opening 156 into the cavity 148 formed between the retainer plate 116 and the divider plate 112. After the gel has been cast, an electric circuit can be formed through a conductive sealant material. Alternatively, the sealant can be removed from the exterior of the cassette 104, thereby exposing the gel inside the cassette 104 to a buffer solution and thereby completing the electric circuit path.

The gel mixture is configured to be in contact with the interior surfaces 120, 140 of the divider plate 112 and the retainer plate 116, respectively. In some embodiments, the interior surfaces 120, 140 of the divider plate 112 and the retainer plate 116, respectively, can be coated. In some embodiments, one or both of the interior surfaces 120, 140 of the plates can be coated with an oxygen interference coating such as SiOₓ, for example, SiO or SiO₂, or any combination thereof or any other suitable coating, to form an oxygen barrier that reduces diffusion from the surface of the plastic plates into the gel. The oxygen barrier is configured to prevent significant local variations in the rate of oxygen diffusion. One or more examples of methods for coating plastic gel molds can be found in U.S. Pat. No. 5,685,967, which is incorporated herein by reference in its entirety. In some embodiments the coating may be substantially transparent. The interior surfaces 120, 140 may be coated manually or mechanically and in some embodiments where the cassette 104 is formed from two separate plates, the coating may be performed before or after joining the divider and retainer plates 112, 116 into the cassette 104. In some embodiments, the interior surfaces 120, 140 of the cassette 104 may be coated under vacuum pressure using evaporation or vapor deposition, sputter deposition, chemical vapor deposition, plasma-enhanced chemical vapor deposition, or any combination thereof. In some embodiments, the coating deposited may be of a thickness less than about 5000 Angstroms in thickness.

In some embodiments, the gel cassettes 104 are about 10 cm by 10 cm for mini-gel cassettes. The gels housed in the gel cassettes are about 7 cm in length (the running length) by about 8 cm wide. The gel cassettes 104 and gels run in the gel cassettes may be any suitable length. In some embodiments, the assembled cassette 104 may include a gap 180 that runs around the outer perimeter of the cassette 104 (shown in FIG. 1). The gap 180 may facilitate the opening of the cassette for gel retrieval.

After the gel has been loaded with sample, the gel cassette 104 containing the samples in the wells may be placed into an electrophoresis device that creates a liquid-tight seal between the external margins of the retainer plate 116 and the divider plate 112. After being placed in the electrophoresis device, the electrode buffer is placed in the anode tank (formed behind the sealed divider) and the cathode tank (formed behind the sealed retainer). When a voltage is applied to the electrophoresis device, anions flow from the cathode tank down through the sample wells and gel into the anode tank, while cations flow into the bottom, and through, the gel from the anode tank. The gel cassette may be used with any suitable electrophoresis device or system.

### Comb

Once the gel material has been poured into the opening 156 of the cassette 104, the comb 108 can be inserted into the opening 156. A polymerization initiator is added to the gel material prior to comb 108 insertion to initiate polymerization of the gel and permit the gel to cast or solidify. Once the gel has been cast, the comb 108 may then be removed, which defines a plurality of voids (or wells or sample wells) in the gel corresponding to teeth of the comb 108. The voids formed by the teeth of the comb 108 are the sample wells in the gel. In one aspect, the comb 108 and assembly 100 as described herein cooperate to prevents excess polymerized gel from contaminating the wells and the area surrounding the wells. In addition, each comb 108 described herein provides wells having greater volumes than standard combs, which permits loading larger sample volume for resolving low abundant or dilute protein samples.

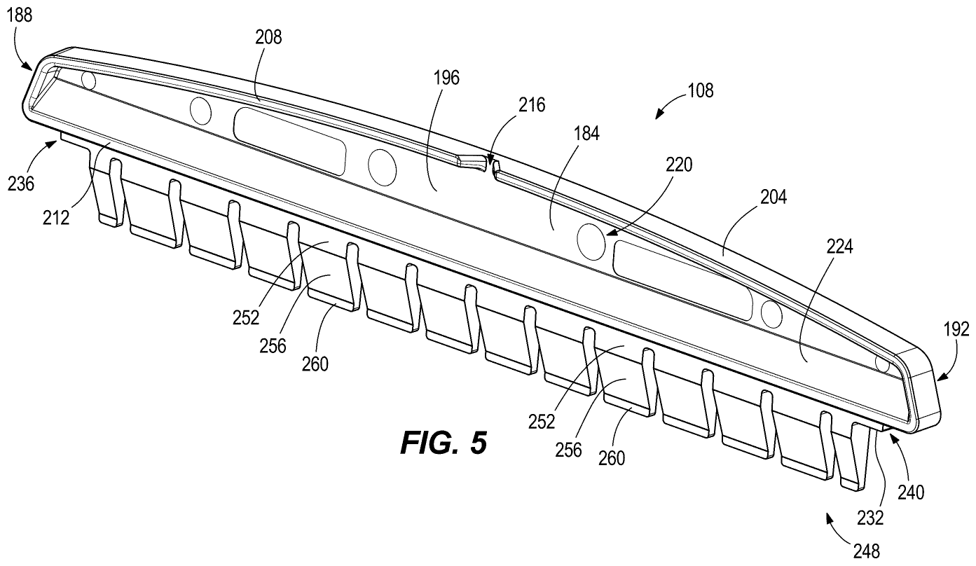

With specific reference to FIG. 5-7, an example of an embodiment of the comb 108 is illustrated. The comb 108 includes an elongate body 184. The elongate body 184 can define a handle such that the elongate body 184 can be grasped by a user to insert the comb 108 into the opening 156 (shown in FIG. 11) of the cassette 104 and/or remove the comb 108 from the cassette 104. The elongate body 184 includes a first end 188 and a second end 192 opposite the first end 188. The elongate body 184 also includes a first side 196 and a second side 200 opposite the first side 196. The first and second sides 196, 200 respectively extend between the first end 188 and the second end 192.

With continued reference to FIG. 5-7, the comb 108 includes a wall 204 extending at least partially around the periphery of the elongate body 184. The illustrated wall 204 extends from the first side 196 of the elongate body 184 in a direction away from the second side 200. The wall 204 includes a lip 208 (also referred to as a flange 208 or a handle 208) and a rim 212. The lip 208 is located at the upper portion of the wall 204. Stated another way, the lip 208 is positioned on a side of the elongate body 184 opposite the opening 156 of the cassette 104. The lip 208 can be grasped by a user to insert the comb 108 into the opening 156 of the cassette 104 and remove the comb 108 from the cassette 104. The rim 212 is located at the lower portion of the wall 204. Stated another way, the rim 212 is positioned on a side of the elongate body 184 adjacent the opening of the cassette 104. The rim 212 engages the front edge 172 of the abutment portion 152 on the retainer plate 116 to inhibit moisture from the gel from escaping the cavity 148. In the illustrated embodiment, the wall 204 includes a slot 216. The slot 216 extends through the lip 208. The slot 216 can define a midpoint between the first end 188 and the second end 192. In some embodiments, the wall 204 may not include a slot 216, such that the wall 204 extends around the entire periphery of the elongate body 184. The wall 204 and the first side 196 together define a recess 220. The recess 220 extends between the first and second ends 188, 192. The recess 220 provides space for a user's finger to engage the lip 208 to grasp and move the comb 108.

As best shown in FIGS. 5 and 11, the comb 108 includes a sloped surface 224 in the recess 220. The sloped surface 224 is on a side of the recess 220 adjacent the rim 212. Once the comb 108 is inserted into the cavity 148 to engage the electrophoresis gel casting solution, some of the electrophoresis gel casting solution can spill out of the cavity 148 and onto the comb 108. The sloped surface 224 has an angle sufficient to allow the electrophoresis gel casting solution to flow down the surface 224 and off of the comb 108. The angle can be 30 degrees relative to a plane defined by the first side 196 of the elongate body 184. In other examples of embodiments, the angle can be approximately 10 degrees, 20 degrees, 40 degrees, 50 degrees, 60 degrees, or any suitable angle relative to the plane defined by the first side 196 to direct a flow of spilled electrophoresis gel casting solution to flow down the surface 224 and off of the comb 108.

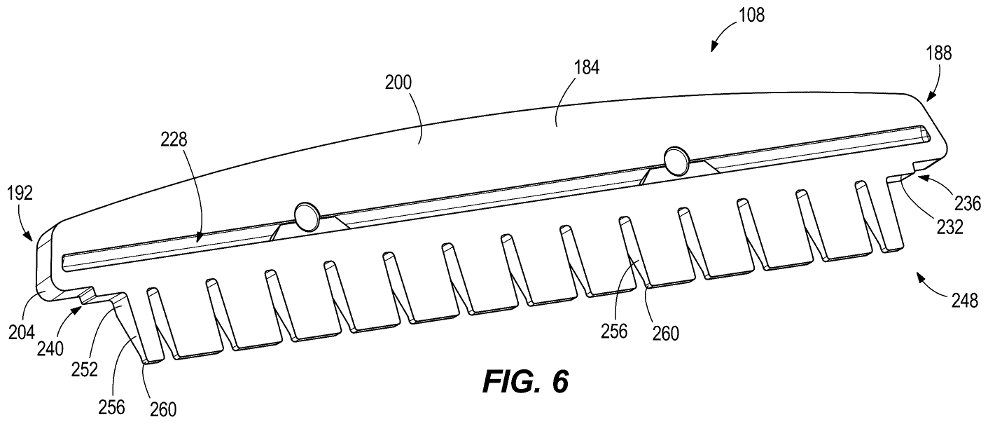

With reference now to FIG. 6, the comb 108 includes a channel 228 (also referred to as a drainage channel 228). The channel 228 allows the electrophoresis gel casting solution to flow therethrough so as to drain from the comb 108 and inhibit or prevent the electrophoresis gel casting solution from contacting a user. The channel 228 extends into the second side 200 of the elongate body 184. The channel 228 extends between the first end 188 and the second end 192. The channel 228 is positioned opposite the sloped surface 224 (shown in FIG. 11). As such, the sloped surface 224 allows the channel 228 to be sufficiently wide to drain the electrophoresis gel casting solution while maintaining a suitable structural rigidity (or structural integrity) of the comb 108. In the illustrated embodiment, the channel 228 is linear and terminates just prior to the wall 204. In other embodiments, the channel 228 can have any suitable shape and be in any suitable position to facilitate draining of the electrophoresis gel casting solution from the comb 108.

With reference to FIG. 5-7, the comb 108 includes an intermediate portion 232. The intermediate portion 232 extends from the wall 204. More specifically, the intermediate portion 232 extends from a side of the rim 212 opposite the lip 208. The intermediate portion 232 extends between the first end 188 and the second end 192 of the elongate body 184. The intermediate portion 232 defines a third end 236 and a fourth end 240 opposite the third end 236. The third end 236 is adjacent the first end 188 of the elongate body 184 and the fourth end 240 is adjacent the second end 192 of the elongate body 184. A distance between the third and fourth ends 236, 240 is less than a distance between the first and second ends 188, 192. The intermediate portion 232 is configured to be received in the cavity 148 in response to insertion of the comb 108 into the cassette 104. In some embodiments, the third end 236 and/or the fourth end 240 can engage the inside surface of the cavity 148 when the comb 108 is connected to the cassette 104.

The comb 108 includes a plurality of teeth 248. The teeth 248 extend from the intermediate portion 232. The teeth 248 are configured to form a plurality of voids or wells (or sample wells) in the gel in the cassette 104. The teeth 248 extend from a side of the intermediate portion 232 opposite the elongate body 184. In some embodiments, each tooth 248 can have at least one angled surface. In some embodiments, each tooth 248 can be, for example, wedge-shaped or comprise a wedge-shaped portion or have at least one angled surface. More specifically, each tooth 248 includes a first portion 252, a second portion 256, and a third portion 260. The first portion 252 is adjacent the intermediate portion 232. The second portion 256 is on a side of the first portion 252 opposite the intermediate portion 232. The third portion 260 is on a side of the second portion 256 opposite the first portion 252.

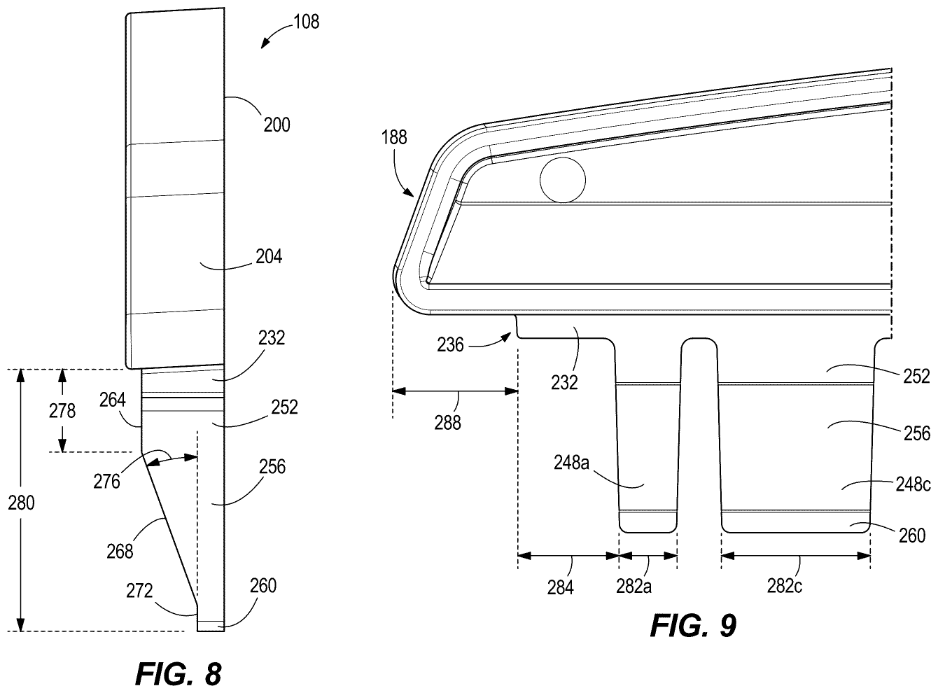

With reference to FIG. 8, which illustrates a side profile of one of the plurality of teeth 248 (or a tooth 248), the first portion 252 defines a first surface 264 (or a first planar surface 264), the second portion 256 defines a second surface 268 (or a second planar surface 268), and the third portion 260 defines a third surface 272 (or a third planar surface 272). The intermediate portion 232 can further define (or be included with) the first surface 264. The first planar surface 264 and the third planar surface 272 are oriented parallel to each other. The second planar surface 268 is oriented oblique relative to the first and third planar surfaces 264, 272. In other examples of embodiments, the first planar surface 264 can be oriented oblique relative to the third planar surface 272. In addition, the second planar surface 268 can be oriented relative to the third planar surface 272 by an angle 276. The angle 276 can be 20 degrees. It should be appreciated that the smaller the angle 276, the longer the teeth 248 can be. In other embodiments, the angle 276 can be any value to achieve a desired height or length of each tooth 248. For example, the angle 276 can be 10 degrees, 15 degrees, 25 degrees, 30 degrees, 35 degrees, more than 35 degrees, etc. In other embodiments, the angle 276 can be any range of values to achieve a desired height or length of each tooth 248. For example, the angle 276 can be between 17.5 and 22.5 degrees, 15 and 25 degrees, 10 and 30 degrees, etc.

With continued reference to FIG. 8, the first portion 252 and the intermediate portion 232 collectively define a first height 278. The value of the first height 278 partially defines a total height 280 of each tooth 248. The greater the total height 280 of each tooth 248, the greater the volume of each tooth 248, the greater the well size, and the greater the amount of sample that can be inserted into the associated well. The first height 278 can be, for example, 1 millimeter (mm), 2 millimeters, 5 millimeters, 10 millimeters, 15 millimeters, or any suitable amount to achieve a desired volume of the teeth 248. In some embodiments, the first height 278 can be defined by the first portion 252 alone.

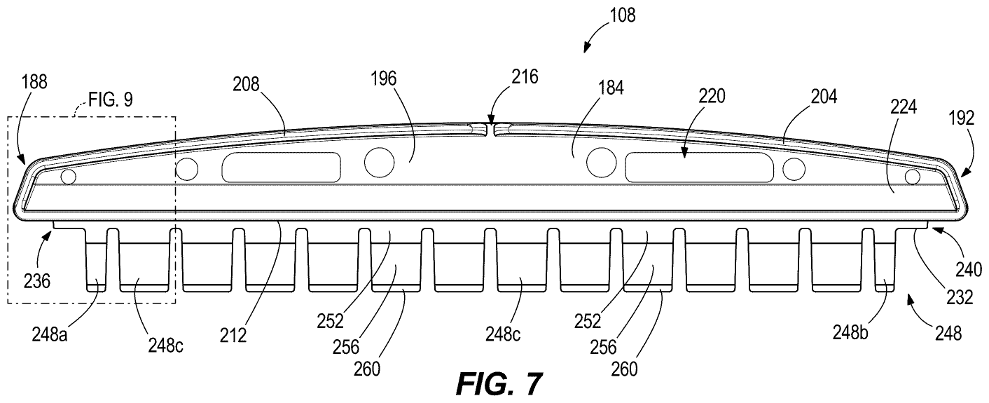

With reference to FIG. 7, the plurality of teeth 248 includes a first tooth 248a adjacent or nearest the third end 236 of the intermediate portion 232, a second tooth 248b adjacent or nearest the fourth end 240 of the intermediate portion 232, and a plurality of third teeth 248c that extend between the first tooth 248a and the second tooth 248b. The illustrated comb 108 includes 12 third teeth 248c, such that the comb 108 includes fourteen total teeth 248. In other embodiments, the comb 108 can include any suitable number of third teeth 248c (e.g., 10, 12, 16, etc.). The first tooth 248a is identical to the second tooth 248b. The third teeth 248c are different than the first and second teeth 248a, 248b.

With reference to FIG. 9, the first tooth 248a has a first width 282a, and the third tooth 248c has a third width 282c. It should be appreciated that the second tooth 248b has a second width. The second width can be identical to the first width 282a. The third width 282c is greater than the first width 282a and the second width. The third width 282c can be, for example, 2 times, 2.5 times, 3 times, etc. larger than the first width 282a and/or the second width.

The dimensions of the teeth 248 (e.g., the first height 278, the total height 280, the first width 282a, the second width, the third width 282c, the angle 276, etc.) affect the volume of the teeth 248. It can be desirable to maximize the volume of the teeth 248 to increase the amount of the sample that can be tested. In the illustrated embodiment, the volume of each of the first and second teeth 248a, 248b is 50 μL. In other embodiments, the volume of each of the first and second teeth 248a, 248b can be, for example, 40 μL, 45 μL, 55 μL, 60 μL, 65 μL or any suitable volume. In the illustrated embodiment, the volume of each third tooth 248c is 123 μL. In other embodiments, the volume of each third tooth 248c can be, for example, 115 μL, 120 μL, 125 μL, 130 μL, 135 μL or any suitable volume. The recommended maximum sample load of the associated wells is less than the volume of the teeth 248. For example, the recommended load volume of a 123 μL well is 100 μL, and the recommended load volume of a 50 μL well is 35 μL.

With continued reference to FIG. 9, the first tooth 248a is spaced apart from the third end 236 of the intermediate portion 232 by a first distance 284. The first distance 284 allows for the well created by the first tooth 248b to be spaced apart from the edge of the gel and the internal edge of the cavity 148 of the cassette 104. The first distance 284 increases the quality, resolution, and sharpness, of the bands during electrophoresis. Such a location of the wells reduces the chance that the bands formed in the gel will turn up at the ends of the band or “smile” or turn down at the ends of the band or turn down at the edges of the band or “frown” or otherwise deviate from the horizontal straightness and become more angled. The first distance 284 can be measured in relation to the first width 282a. For example, the first distance 284 can be equal to the first width 282a, greater than the first width 282a, or smaller than the first width 282a. The first distance 284 can be greater than 1.5 times, 2 times, 2.5 times, etc. greater or smaller than the first width 282a. Alternatively, the first distance 284 can be measured numerically. For example, the first distance 284 can be 1 millimeter (mm), 2 mm, 3 mm, 5 mm, 10 mm, 15 mm, 20 mm, etc. The first distance 284 can be any suitable distance to improve the quality, resolution, and sharpness, of the bands during electrophoresis. It should be appreciated that the second tooth 248b is spaced apart from the fourth end 240 of the intermediate portion 232 by a second distance. The second distance can be identical to the first distance 284. The second distance can have any qualities described herein with reference to the first distance 284.

With continued reference to FIG. 9, the first end 188 of the elongated body 184 and the third end 236 of the intermediate portion 232 are spaced apart by a third distance 288. The third distance 288 can be adjusted to adjust the first distance 284. In some embodiments, the third distance 288 may be zero. It should be appreciated that the second end 192 of the elongated body 184 and the fourth end 240 of the intermediate portion 232 are spaced apart by a fourth distance. The fourth distance can be identical to the third distance 288. The fourth distance can have any qualities described herein with reference to the third distance 288.

In some embodiments, the wells created by insertion of the comb 108 described herein (e.g., comb 108 with teeth 248 having at least one angled surface) into the gel material can provide a larger opening to the well at the top and thereby create easier access to the wells using a standard pipette tip on a single pipette or on a multi-channel pipette. Additionally, the wells described herein permit a greater amount of sample to be loaded into a thinner gel (for example, approximately 1 mm thick gels). The comb 108 may be used with the cassette 104 described herein, or may be used with any other suitable cassette for creating a gel.

The wells in the gel created by the teeth 248 described herein may be of a volume at least 12% greater than the volume of the wells created using a standard comb. In some embodiments, the wells may have a volume that is at least 10% greater, at least 20% greater, at least 50% greater, at least 100% greater, at least 150% greater, at least 175% greater, at least 200% greater, at least 250% greater than a well created using a standard comb. Additionally, the wells allow for loading an increased amount of sample while maintaining or improving band sharpness and resolution during electrophoresis.

In some embodiments, the wells comprising a wedge-shaped portion (or wedge-shaped wells) created by insertion of the comb 108 with the teeth 248 having a wedge-shaped portion (or wedge-shaped teeth 248) into the gel material can provide a larger opening to the well at the top and thereby create easier access to the wells using a standard pipette tip on a single pipette or on a multi-channel pipette. Additionally, the wells comprising a wedge-shaped portion permit a greater amount of sample to be loaded into a thinner gel (for example, approximately 1 mm thick gels). The comb 108 may be used with the cassette 104 described herein, or may be used with any other suitable cassette for creating a gel.

The wells comprising a wedge-shaped portion in the gel created by the teeth 248 having a wedge-shaped portion may be of a volume at least 12% greater than the volume of the wells created using a standard comb. In some embodiments, the wells comprising a wedge-shaped portion may have a volume that is at least 10% greater, at least 20% greater, at least 50% greater, at least 100% greater, at least 150% greater, at least 175% greater, at least 200% greater, at least 250% greater than a well created using a standard comb. Additionally, the wells comprising a wedge-shaped portion allow for loading an increased amount of sample while maintaining or improving band sharpness and resolution during electrophoresis.

In some embodiments, the comb 108 may be molded from any suitable plastic including, but not limited to polymers such as polyethylene terephthalate, polyvinyl chloride, polymethyl methacrylate, polystyrene, polyethylene, polymethyl polypropylene, cellulose acetates, co-polymers, polycarbonate, or any other suitable material. In some embodiments, the dimensions of the teeth 248 may be uniform along the length of the comb 108 or the teeth may have varying dimensions along the length of the comb. The teeth 248 may or may not be the same shape as the wedge-shaped opening 156 of the cassette 104.

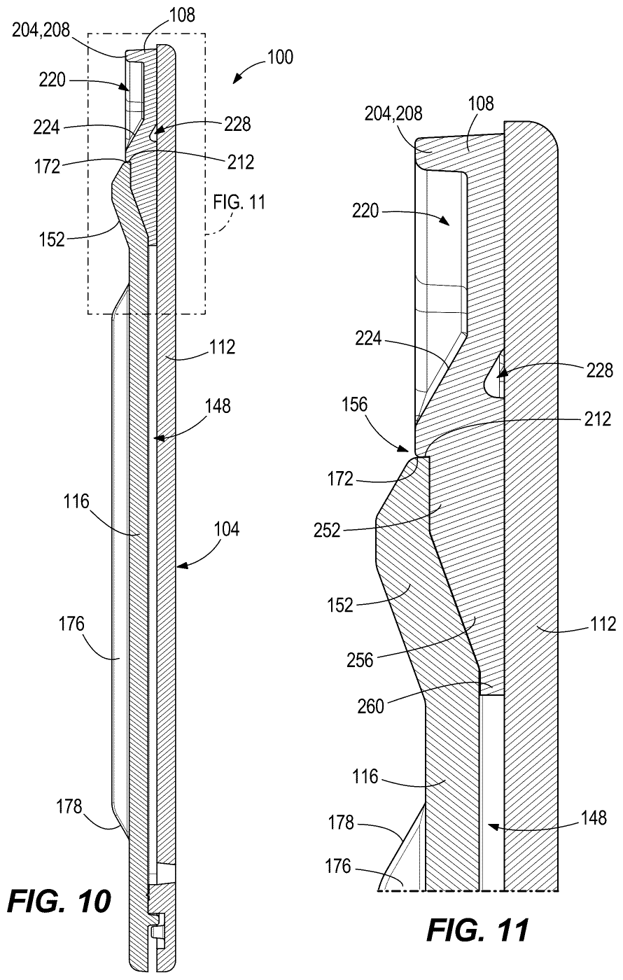

With reference to FIGS. 10 and 11, the comb 108 is coupled to the cassette 104. The rim 212 engages the front edge 172 of the abutment portion 152 on the retainer plate 116 to inhibit moisture from the gel from escaping the cavity 148. This inhibits the gel from drying out during, for example, storage or transportation of the gel electrophoresis assembly 100.

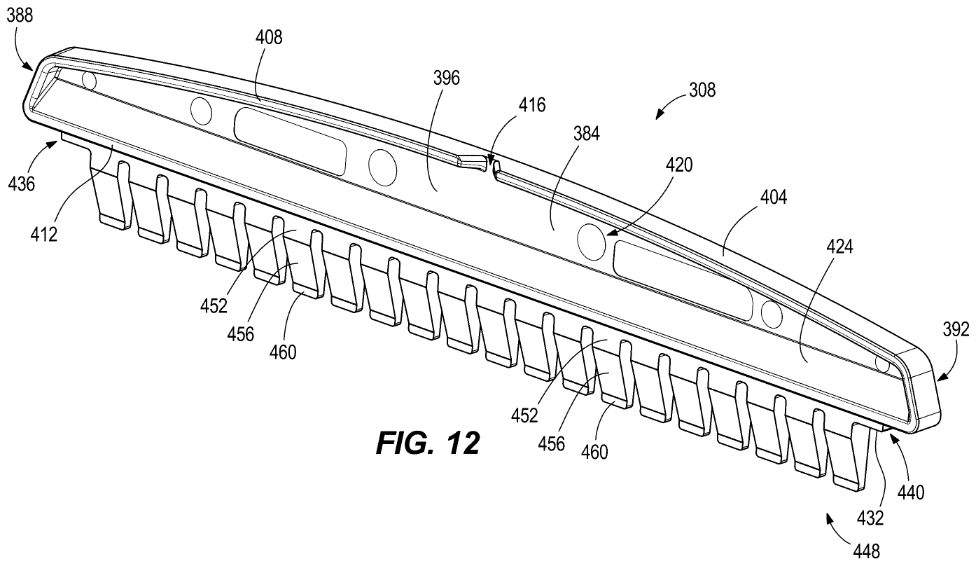

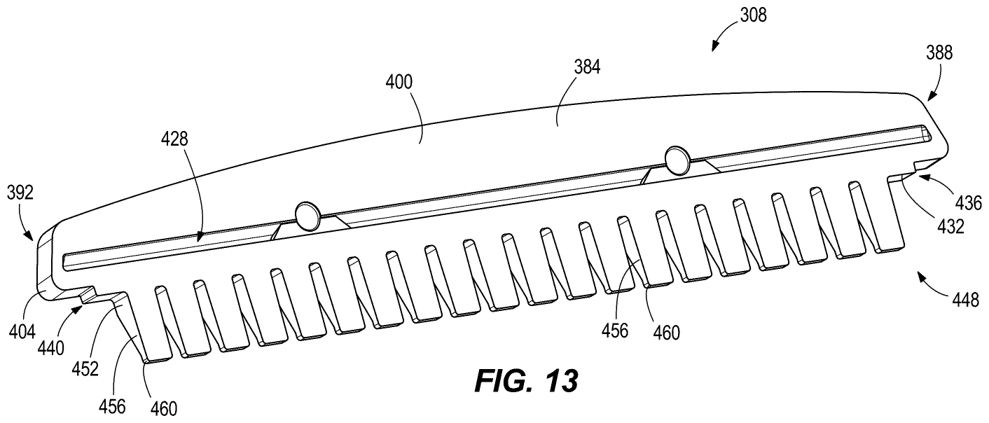

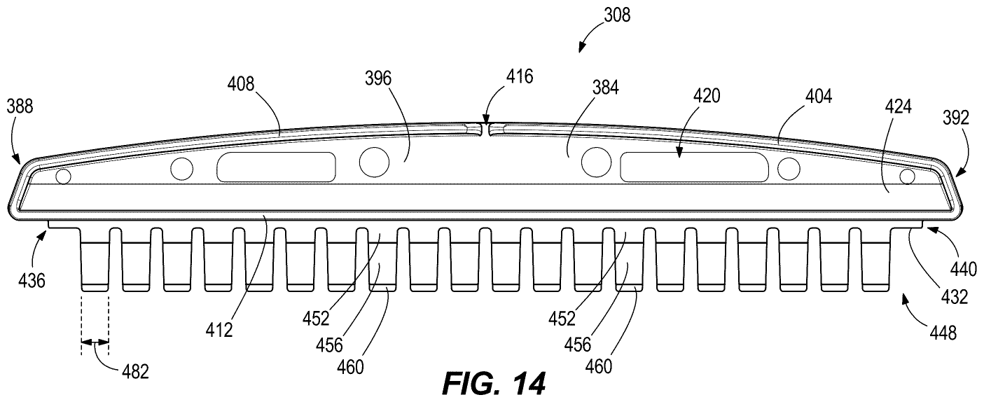

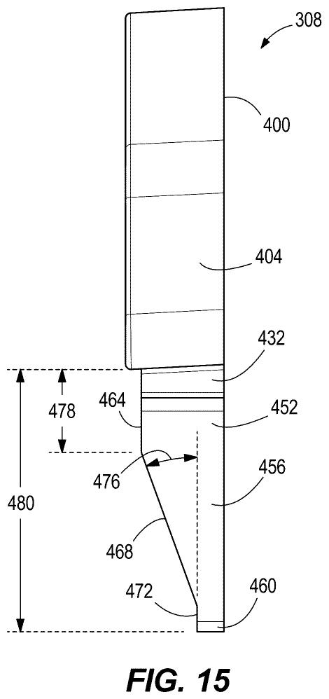

FIG. 12-15 illustrate another embodiment of a comb 308. The comb 308 can be used in the gel electrophoresis assembly 100 in place of the comb 108. As such, the comb 308 can be received in the cavity 148 of the cassette 104. For the sake of brevity, only differences between the comb 308 and the comb 108 are discussed herein. However, it should be appreciated that the comb 308 can include any features or function as described herein with reference to the comb 108. Similarly, the comb 108 can include any features or function as described herein with reference to the comb 308. Like features and components between the comb 308 and the comb 108 will be labeled similarly, but the reference numbers will be increased by 200 (or plus a value of two hundred). For example, the comb 308 includes an elongate body 384 identical to the elongate body 184 of the comb 108.

With reference to FIG. 12-14, the comb 308 includes a plurality of teeth 448. Each tooth 448 is identical and defines width 482. The dimensions of the teeth 448 affect the volume of the teeth 448. It is desired to maximize the volume of the teeth 448 to, for example, increase the amount of the sample that can be tested. In the illustrated embodiment, the volume of each tooth 448 is 70 μL. In other embodiments, the volume of the teeth 448 can be, for example, 60 μL, 65 μL, 75 μL, 80 μL, 85 μL or any suitable volume. The recommended maximum sample load of the associated wells is less than the volume of the teeth 448. For example, the recommended load volume of a 70 μL well is 60 μL. The illustrated comb 308 includes 20 teeth 448. In other embodiments, the comb 308 can include a different number of teeth 448 to achieve a desired number of wells.

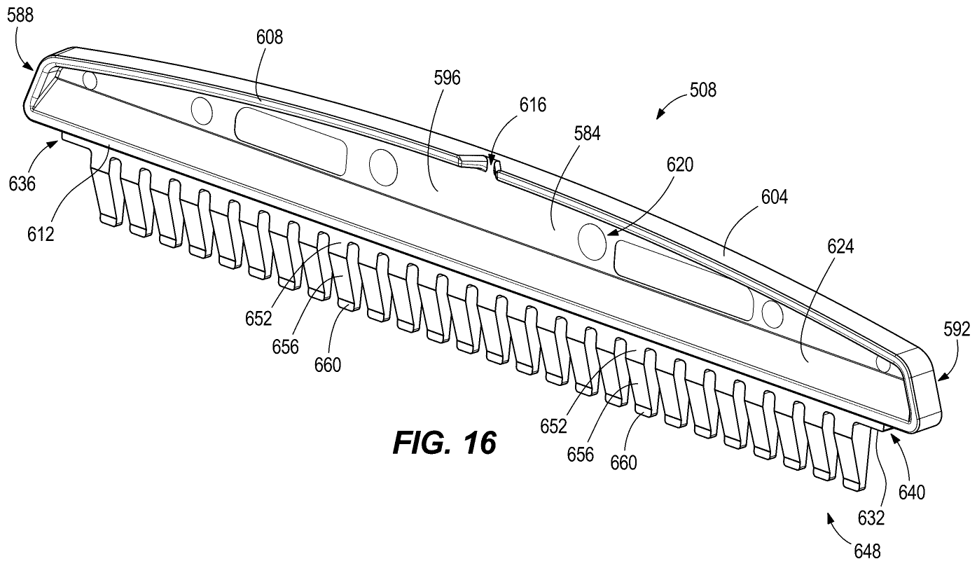

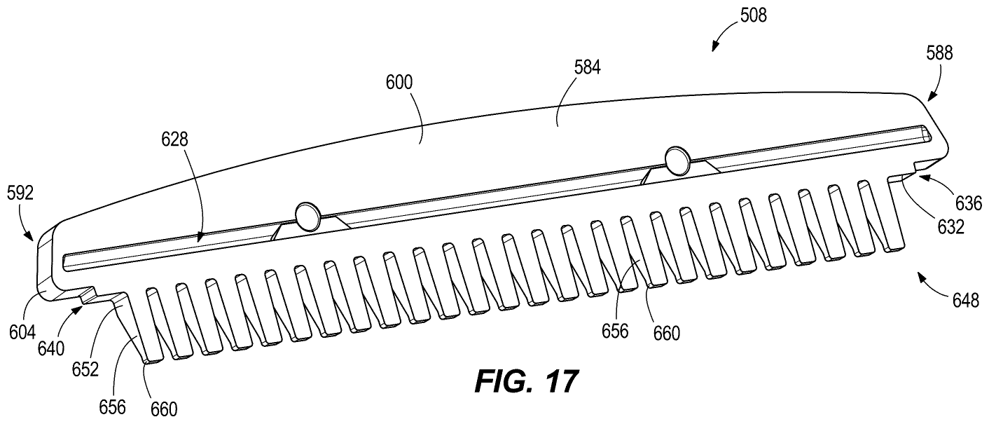

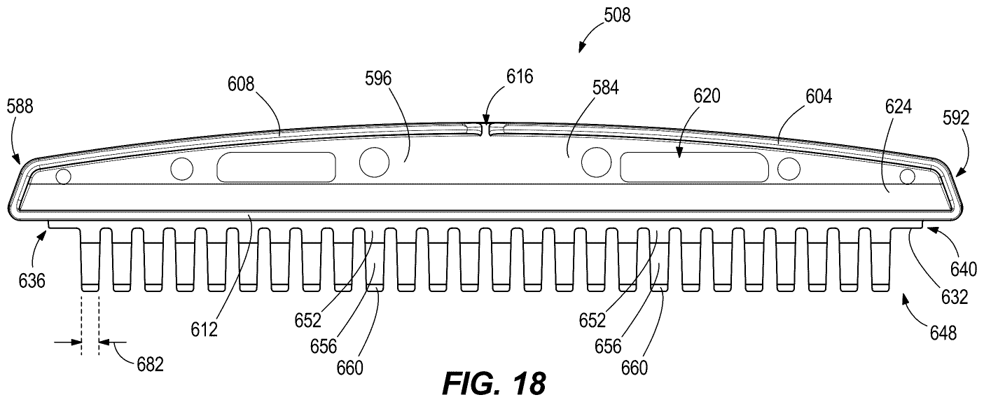

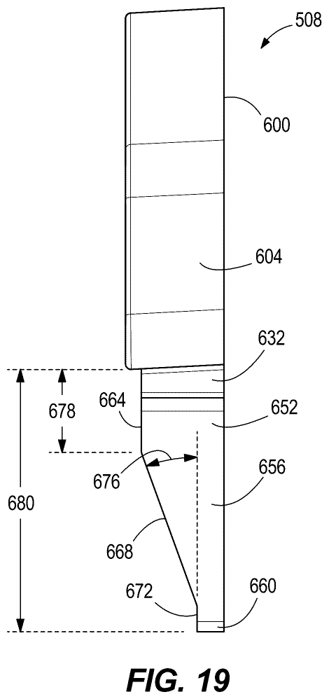

FIG. 16-19 illustrate another embodiment of a comb 508. The comb 508 can be used in the gel electrophoresis assembly 100 in place of the comb 108 and the comb 308. As such, the comb 508 can be received in the cavity 148 of the cassette 104. For the sake of brevity, only differences between the comb 508 and the combs 108, 308 are discussed herein. However, it should be appreciated that the comb 508 can include any features or function as described herein with reference to the combs 108, 308. Similarly, the combs 108, 308 can include any features or function as described herein with reference to the comb 508. Like features between the comb 508 and the comb 108 will be labeled similarly, but the reference numbers will be increased by 400 (or plus a value of four hundred). For example, the comb 508 includes an elongate body 584 identical to the elongate body 184 of the comb 108.

With reference to FIG. 16-18, the comb 508 includes a plurality of teeth 648. Each tooth 648 is identical and defines a width 682. The dimensions of the teeth 648 affect the volume of the teeth 648. It is desired to maximize the volume of the teeth 648 to, for example, increase the amount of the sample that can be tested. In the illustrated embodiment, the volume of each tooth 648 is 46 μL. In other embodiments, the volume of the teeth 648 can be, for example, 35 μL, 40 μL, 45 μL, 50 μL, 55 μL, 60 μL, or any suitable volume. The recommended maximum sample load of the associated wells is less than the volume of the teeth 648. For example, the recommended load volume of a 46 μL well is 40 μL. The illustrated comb 508 includes 26 teeth 648. In other embodiments, the comb 508 can include a different number of teeth 648 to achieve a desired number of wells.

### Methods

Another embodiment described herein is a method for efficiently loading one or more large-volume samples in an electrophoretic gel, the method comprising: providing an assembly comprising the cassette described herein and at least one comb described herein. A gel is cast by initiation polymerization of electrophoresis gel casting solution, pouring a sufficient amount of this into the cassette, and the comb is inserted into the cassette and the gel is allowed to polymerize. The gel can then be stored, packaged, or used immediately. To use the gel, the cassette and comb assembly is configured into an electrophoretic gel running apparatus. A running buffer, typically consisting of 25 mM Tris hydroxy aminomethane (Tris), 192 mM glycine, pH 8.3, and 0.1% sodium docecyl sulfate (SDS), is introduced and the comb is removed from the assembly. The comb can be removed prior to introducing the buffer. One or more samples are loaded into the sample wells, and electrophoresis is commenced by introducing an electric current.

Another embodiment described herein is a method for running multiple samples on an electrophoretic gel without band shape distortion in the samples proximate to the gel edges, the method comprising: providing an assembly comprising the cassette described herein and at least one comb described herein, introducing one or more samples into one or more wells; and applying an electric current to induce electrophoresis. The sample wells proximate to the gel edges are inset inward towards the gel center. This prevents the samples closest to the gel edges from being adversely affected by current channeling along the gel edges resulting in band distortion or curvature.

Another embodiment described herein is a method for casting and loading an electrophoretic gel without excess polymerized gel casting solution contaminating the wells, the method comprising: providing an assembly comprising the cassette described herein and at least one comb described herein, introducing a sufficient amount of electrophoresis gel casting solution to fill the cassette, wherein the electrophoresis gel casting solution comprises polyacrylamide, one or more buffers, and optionally a detergent, and wherein polymerization of the electrophoresis gel casting solution has been initiated by the addition of a polymerization initiator and optionally a polymerization accelerator; inserting the comb into the cassette and unpolymerized gel; permitting the electrophoresis gel casting solution to polymerize for a period of time. The gel can then be stored, packaged, or used immediately. To use the gel, the cassette and comb assembly is configured into the running apparatus. The comb is removed from the cassette, wherein up on removal minimal excess polymerized gel casting solution exists in or surrounding one or more wells. The samples can easily be load into one or more wells.

Another embodiment described herein is a method for detecting low abundant-proteins or proteins in dilute samples by loading large sample volumes: providing an assembly comprising the cassette described herein and at least one comb described herein; removing the comb from the assembly; introducing one or more samples into one or more wells, wherein the wells comprise volumes of 40-100 μL; and applying an electric current to induce electrophoresis.

### Kits

Another embodiment described herein is a kit comprising an assembly comprising the cassette described herein and at least one comb described herein; polymerized electrophoresis gel casting solution comprising polyacrylamide, one or more buffers, and optionally a detergent; packaging comprising bags, pouches, plastic containers, or boxes; buffer solution; and optionally, instructions for use.

Another embodiment is a pre-poured electrophoretic gel assembly ready for use. The gel assembly comprises a cassette as described herein. An electrophoretic gel comprising polyacrylamide, buffer, optionally detergent has been pre-cast with a comb as described herein. The pre-poured gel/cassette/comb assembly has been packaged in a sealed bag or pouch with a sufficient amount of buffer or solution to keep the gel moist and prevent dehydration or drying. The cassette design prevents puncturing the bag or pouch by eliminating sharp edges. One or more of the pre-poured gel/cassette/comb assemblies may be packaged together or in individual packaging. A plurality of the pre-poured gel/cassette/comb assemblies may be included in a kit. The kit may further comprise, SDS PAGE running buffer concentrate, sample loading buffer concentrate, protein staining concentrates, destaining concentrates, molecular weight markers, containers, labels, and instructions for use. In some embodiments an electrophoresis running apparatus and/or power supply may be included in the kit. The kit may be provided in a sealed box with labeling and branding.

It will be apparent to one of ordinary skill in the relevant art that suitable modifications and adaptations to the compositions, formulations, methods, processes, and applications described herein can be made without departing from the scope of any embodiments or aspects thereof. The compositions and methods provided are exemplary and are not intended to limit the scope of any of the specified embodiments. All of the various embodiments, aspects, and options disclosed herein can be combined in any variations or iterations. The scope of the compositions, formulations, methods, and processes described herein include all actual or potential combinations of embodiments, aspects, options, examples, and preferences herein described. The exemplary compositions and formulations described herein may omit any component, substitute any component disclosed herein, or include any component disclosed elsewhere herein. The ratios of the mass of any component of any of the compositions or formulations disclosed herein to the mass of any other component in the formulation or to the total mass of the other components in the formulation are hereby disclosed as if they were expressly disclosed. Should the meaning of any terms in any of the patents or publications incorporated by reference conflict with the meaning of the terms used in this disclosure, the meanings of the terms or phrases in this disclosure are controlling. Furthermore, the foregoing discussion discloses and describes merely exemplary embodiments. All patents and publications cited herein are incorporated by reference herein for the specific teachings thereof.

Various embodiments and aspects of the inventions described herein are summarized by the following clauses:
Clause 1. An assembly for gel electrophoresis comprising:
   a gel cassette comprising a retainer plate and a divider plate coupled to form a cavity between the retainer plate and the divider plate; and
   a comb comprising
      an elongated body having a first end and a second end,
      an intermediate portion connected to the elongated body and extending between the first end and the second end, the intermediate portion having a third end and a fourth end, the third end adjacent the first end of the elongated body, the fourth end adjacent the second end of the elongated body, the intermediate portion received in the cavity, and
      a plurality of teeth extending from the intermediate portion between the first end and the second end, the plurality of teeth spaced apart from at least one of the third end and the fourth end.
Clause 2. The assembly of clause 1, wherein:
   the plurality of teeth includes a first tooth nearest the third end of the intermediate portion,
   the first tooth has a first width,
   the first tooth is spaced apart from the third end of the intermediate portion by a first distance, and
   the first distance is greater than the first width.
Clause 3. The assembly of clause 1 or 2, wherein:
   the plurality of teeth includes a second tooth nearest the fourth end of the intermediate portion,
   the second tooth has a second width,
   the second tooth is spaced apart from the fourth end of the intermediate portion by a second distance, and
   the second distance is greater than the second width.
Clause 4. The assembly of any one of clauses 1-3, wherein the first width is identical to the second width.
Clause 5. The assembly of any one of clauses 1-4, wherein the first distance is identical to the second distance.
Clause 6. The assembly of any one of clauses 1-5, wherein each tooth of the plurality of teeth has an identical width.
Clause 7. The assembly of any one of clauses 1-6, wherein:
   the plurality of teeth includes a third tooth between the first tooth and the second tooth,
   the third tooth has a third width, and
   the third width is greater than the first width and/or the second width.
Clause 8. The assembly of any one of clauses 1-7, wherein the third width is more than twice the first width, and wherein the third width is more than twice the second width.
Clause 9. The assembly of any one of clauses 1-8, wherein each of the plurality of teeth includes a first portion and a second portion on a side of the first portion opposite the intermediate portion, and wherein the second portion is angled relative to the first portion.
Clause 10. The assembly of any one of clauses 1-9, wherein the second portion is angled 15 to 25 degrees relative to the first portion.
Clause 11. The assembly of any one of clauses 1-10, wherein:
   each of the plurality of teeth includes a third portion on a side of the second portion opposite the first portion,
   the first portion defines a first planar surface,
   the third portion defines a third planar surface, and
   the first planar surface is parallel to the third planar surface.
Clause 12. The assembly of any one of clauses 1-11, wherein at least one of the plurality of teeth has a volume of at least 123 μL.
Clause 13. The assembly of any one of clauses 1-12, wherein at least one of the plurality of teeth has a volume of at least 50 μL.
Clause 14. The assembly of any one of clauses 1-13, wherein at least one of the plurality of teeth has a volume of at least 70 μL.
Clause 15. The assembly of any one of clauses 1-14, wherein each of the plurality of teeth has a volume of at least 70 μL.
Clause 16. The assembly of any one of clauses 1-15, wherein at least one of the plurality of teeth has a volume of at least 46 μL.
Clause 17. The assembly of any one of clauses 1-16, wherein each of the plurality of teeth has a volume of at least 46 μL.
Clause 18. The assembly of any one of clauses 1-17, wherein:
   the first tooth has a volume of at least 50 μL,
   the second tooth has a volume of at least 50 μL, and
   the third tooth has a volume of at least 123 μL.
Clause 19. The assembly of any one of clauses 1-18, wherein the plurality of teeth is spaced apart from the third end by 1 to 5 millimeters, and wherein the plurality of teeth is spaced apart from the fourth end by 1 to 5 millimeters.
Clause 20. The assembly of any one of clauses 1-19, wherein the plurality of teeth is spaced apart from the third end by 6 to 10 millimeters, and wherein the plurality of teeth is spaced apart from the fourth end by 6 to 10 millimeters.
Clause 21. The assembly of any one of clauses 1-20, wherein the plurality of teeth is spaced apart from the third end by 11 to 15 millimeters, and wherein the plurality of teeth is spaced apart from the fourth end by 11 to 15 millimeters.
Clause 22. A comb for gel electrophoresis comprising:
   an elongated body including a first end and a second end;
   a wall extending at least partially around a periphery of the elongated body;
   an intermediate portion connected to the wall and extending between the first end and the second end of the elongated body, the intermediate portion having a third end and a fourth end opposite the third end, the third end adjacent the first end of the elongated body, the fourth end adjacent the second end of the elongated body; and
   a plurality of teeth extending from the intermediate portion between the third end and the fourth end, the plurality of teeth spaced apart from at least one of the third end and the fourth end.
Clause 23. The comb of clause 22, wherein:
   the plurality of teeth includes a first tooth nearest the third end of the intermediate portion,
   the first tooth has a first width,
   the first tooth is spaced apart from the third end of the intermediate portion by a first distance, and
   the first distance is greater than the first width.
Clause 24. The comb of clause 22 or 23, wherein:
   the plurality of teeth includes a second tooth nearest the fourth end of the intermediate portion,
   the second tooth has a second width,
   the second tooth is spaced apart from the fourth end of the intermediate portion by a second distance, and
   the second distance is greater than the second width.
Clause 25. The comb of any one of clauses 22-24, wherein the first width is identical to the second width.
Clause 26. The comb of any one of clauses 22-25, wherein the first distance is identical to the second distance.
Clause 27. The comb of any one of clauses 22-26, wherein each tooth of the plurality of teeth has an identical width.
Clause 28. The comb of any one of clauses 22-27, wherein:
   the plurality of teeth includes a third tooth between the first tooth and the second tooth,
   the third tooth has a third width, and
   the third width is greater than the first width and the second width.
Clause 29. The comb of any one of clauses 22-28, wherein the third width is more than twice the first width, and wherein the third width is more than twice the second width.
Clause 30. The comb of any one of clauses 22-29, wherein each of the plurality of teeth includes a first portion and a second portion on a side of the first portion opposite the intermediate portion, and wherein the second portion is angled relative to the first portion.
Clause 31. The comb of any one of clauses 22-30, wherein the second portion is angled 15 to 25 degrees relative to the first portion.
Clause 32. The comb of any one of clauses 22-31, wherein:
   each of the plurality of teeth includes a third portion on a side of the second portion opposite the first portion,
   the first portion defines a first planar surface,
   the third portion defines a third planar surface, and
   the first planar surface is parallel to the third planar surface.
Clause 33. The comb of any one of clauses 22-31, wherein at least one of the plurality of teeth has a volume of at least 123 μL.
Clause 34. The comb of any one of clauses 22-33, wherein at least one of the plurality of teeth has a volume of at least 50 μL.
Clause 35. The comb of any one of clauses 22-34, wherein at least one of the plurality of teeth has a volume of at least 70 μL.
Clause 36. The comb of any one of clauses 22-35, wherein each of the plurality of teeth has a volume of at least 70 μL.
Clause 37. The comb of any one of clauses 22-36, wherein at least one of the plurality of teeth has a volume of at least 46 μL.
Clause 38. The comb of any one of clauses 22-37, wherein each of the plurality of teeth has a volume of at least 46 μL.
Clause 39. The comb of any one of clauses 22-38, wherein:
   the first tooth has a volume of at least 50 μL,
   the second tooth has a volume of at least 50 μL, and
   the third tooth has a volume of at least 123 μL.
Clause 40. The comb of any one of clauses 22-39, wherein the plurality of teeth is spaced apart from the third end by 1 to 5 millimeters, and wherein the plurality of teeth is spaced apart from the fourth end by 1 to 5 millimeters.
Clause 41. The comb of any one of clauses 22-40, wherein the plurality of teeth is spaced apart from the third end by 6 to 10 millimeters, and wherein the plurality of teeth is spaced apart from the fourth end by 6 to 10 millimeters.
Clause 42. The comb of any one of clauses 22-41, wherein the plurality of teeth is spaced apart from the third end by 11 to 15 millimeters, and wherein the plurality of teeth is spaced apart from the fourth end by 11 to 15 millimeters.
Clause 43. An assembly for gel electrophoresis comprising:
   a gel cassette configured to accommodate an electrophoresis gel casting solution, the gel cassette including a retainer plate and a divider plate coupled to form a cavity between the retainer plate and the divider plate, the retainer plate having an upper edge adjacent an opening to the cavity; and
   a comb including
      an elongated body having
         a first end,
         a second end opposite the first end, and
         a channel extending between the first end and the second end,
      a plurality of teeth extending from the elongated body between the first end and the second end, and
      a wall extending at least partially around a periphery of the elongated body, a portion of the wall configured to engage the upper edge of the retainer plate.
Clause 44. The assembly of clause 43, wherein the wall extends from a first side of the elongated body, and wherein the channel extends along a second side of the elongated body opposite the first side.
Clause 45. The assembly of clause 43 or 44, wherein the wall includes a rim extending between the first end and the second end and a lip extending between the first end and the second end, and wherein the rim engages the upper edge of the retainer plate.
Clause 46. The assembly of any one of clauses 43-45, wherein a recess is defined between the rim and the lip, and wherein the lip improves access to the elongated body to assist removal of the comb from the gel cassette.
Clause 47. The assembly of any one of clauses 43-46, wherein the elongated body includes a sloped surface in the recess and adjacent the rim, and wherein the electrophoresis gel casting solution is configured to flow along the sloped surface and off the comb.
Clause 48. The assembly of any one of clauses 43-47, wherein the sloped surface is angled at 30 degrees relative to elongated body.
Clause 49. The assembly of any one of clauses 43-48, wherein the sloped surface is positioned on a side of the elongated body opposite the channel.
Clause 50. The assembly of any one of clauses 43-49, wherein the retainer plate includes:
   a retainer body,
   an abutment portion extending along the retainer body adjacent the opening, the abutment portion having the upper edge, the abutment portion having tapered edges, and
   a rail extending along the retainer body, the rail spaced apart from the abutment portion, the rail having tapered edges.
Clause 51. The assembly of any one of clauses 43-50, wherein:
   the comb includes an intermediate portion between the elongated body and the plurality of teeth,
   the intermediate portion extends between the first end and the second end of the elongated body,
   the intermediate portion has a third end and a fourth end opposite the third end, and
   the third and the fourth ends engage an internal edge of the cavity.
Clause 52. The assembly of any one of clauses 43-51, wherein the channel extends past the third end and the fourth end.
Clause 53. The assembly of any one of clauses 43-52, wherein the plurality of teeth is spaced apart from at least one of the third end and the fourth end.
Clause 54. The assembly of any one of clauses 43-53, wherein the assembly further comprises polymerized electrophoresis gel casting solution comprising polyacrylamide, one or more buffers, and optionally a detergent.
Clause 55. A comb for gel electrophoresis comprising:
   an elongated body including:
      a first end,
      a second end opposite the first end, and
      a channel extending between the first end and the second end;
   a wall extending at least partially around a periphery of the elongated body, the wall including a rim extending between the first end and the second end and a lip extending between the first end and the second end; and
   a plurality of teeth extending from the elongated body between the first end and the second end.
Clause 56. The comb of clause 55, wherein the wall extends from a first side of the elongated body, and wherein the channel extends along a second side of the elongated body opposite the first side.
Clause 57. The comb of clause 55 or 56, wherein a recess is defined between the rim and the lip, and wherein the lip improves access to the elongated body.
Clause 58. The comb of any one of clauses 55-57, wherein the elongated body includes a sloped surface in the recess and adjacent the rim, and wherein an electrophoresis gel casting solution is configured to flow along the sloped surface and off the comb.
Clause 59. The comb of any one of clauses 55-58, wherein the sloped surface is angled at 30 degrees relative to the elongated body.
Clause 60. The comb of any one of clauses 55-59, wherein the sloped surface is positioned on a side of the elongated body opposite the channel.
Clause 61. The comb of any one of clauses 55-60, wherein:
   the comb includes an intermediate portion between the elongated body and the plurality of teeth,
   the intermediate portion extends between the first end and the second end of the elongated body, and
   the intermediate portion has a third end and a fourth end opposite the third end.
Clause 62. The comb of any one of clauses 55-61, wherein the channel extends past the third end and the fourth end.
Clause 63. The comb of any one of clauses 55-62, wherein the plurality of teeth is spaced apart from at least one of the third end and the fourth end.
Clause 64. An assembly for gel electrophoresis comprising:
   a gel cassette comprising a retainer plate and a divider plate coupled to form a cavity between the retainer plate and the divider plate, the retainer plate having an upper edge adjacent an opening to the cavity; and
   a comb including
      an elongated body having a first end and a second end opposite the first end, and
      a wall extending at least partially around a periphery of the elongated body, the wall including a rim extending between the first end and the second end, the rim in contact with the upper edge of the retainer plate, and
      a plurality of teeth extending from the wall between the first end and the second end of the elongated body.
Clause 65. The assembly of clause 64, wherein the elongated body includes a channel extending between the first end and the second end.
Clause 66. The assembly of clause 64 or 65, wherein the wall extends from a first side of the elongated body, and wherein the channel extends along a second side of the elongated body opposite the first side.
Clause 67. The assembly of any one of clauses 64-66, wherein each of the plurality of teeth includes a first portion and a second portion on a side of the first portion opposite the wall, and wherein the second portion is angled relative to the first portion.
Clause 68. The assembly of any one of clauses 64-67, wherein the second portion is angled 15 to 25 degrees relative to the first portion.
Clause 69. The assembly of any one of clauses 64-68, wherein:
   each of the plurality of teeth includes a third portion on a side of the second portion opposite the first portion,
   the first portion defines a first planar surface,
   the third portion defines a third planar surface, and
   the first planar surface is parallel to the third planar surface.
Clause 70. The assembly of any one of clauses 64-69, wherein at least one of the plurality of teeth has a volume of at least 123 μL.
Clause 71. The assembly of any one of clauses 64-70, wherein at least one of the plurality of teeth has a volume of at least 50 μL.
Clause 72. The assembly of any one of clauses 64-71, wherein at least one of the plurality of teeth has a volume of at least 70 μL.
Clause 73. The assembly of any one of clauses 64-72, wherein each of the plurality of teeth has a volume of at least 70 μL.
Clause 74. The assembly of any one of clauses 64-73, wherein at least one of the plurality of teeth has a volume of at least 46 μL.
Clause 75. The assembly of any one of clauses 64-74, wherein each of the plurality of teeth has a volume of at least 46 μL.
Clause 76. A comb for gel electrophoresis, the comb configured to be received in a cassette including an upper edge, the comb comprising:
   an elongated body including a first end and a second end;
   a wall extending at least partially around a periphery of the elongated body, the wall including a rim extending between the first end and the second end, the rim configured to engage the upper edge of the cassette;
   an intermediate portion connected to the wall and extending between the first end and the second end of the elongated body; and
   a plurality of teeth extending from the intermediate portion.
Clause 77. The comb of clause 76, wherein the elongated body includes a channel extending between the first end and the second end.
Clause 78. The comb of clause 76 or 77, wherein the wall extends from a first side of the elongated body, and wherein the channel extends along a second side of the elongated body opposite the first side.
Clause 79. The comb of any one of clauses 76-78, wherein each of the plurality of teeth includes a first portion and a second portion on a side of the first portion opposite the intermediate portion, and wherein the second portion is angled relative to the first portion.
Clause 80. The comb of any one of clauses 76-79, wherein the second portion is angled 15 to 25 degrees relative to the first portion.
Clause 81. The comb of any one of clauses 76-80, wherein:
   each of the plurality of teeth includes a third portion on a side of the second portion opposite the first portion,
   the first portion defines a first planar surface,
   the third portion defines a third planar surface, and
   the first planar surface is parallel to the third planar surface.
Clause 82. The comb of any one of clauses 76-81, wherein at least one of the plurality of teeth has a volume of at least 123 μL.
Clause 83. The comb of any one of clauses 76-82, wherein at least one of the plurality of teeth has a volume of at least 50 μL.
Clause 84. The comb of any one of clauses 76-83, wherein at least one of the plurality of teeth has a volume of at least 70 μL.
Clause 85. The comb of any one of clauses 76-84, wherein each of the plurality of teeth has a volume of at least 70 μL.
Clause 86. The comb of any one of clauses 76-85, wherein at least one of the plurality of teeth has a volume of at least 46 μL.
Clause 87. The comb of any one of clauses 76-86, wherein each of the plurality of teeth has a volume of at least 46 μL.
Clause 88. A kit comprising:
   the assembly of any one of clauses 1-21, 43-54, or 64-75;
   polymerized electrophoresis gel casting solution comprising polyacrylamide, one or more buffers, and optionally a detergent;
   packaging comprising bags, pouches, plastic containers, or boxes;
   buffer solution; and
   optionally, instructions for use.
Clause 89. A method for efficiently loading one or more large-volume samples in an electrophoretic gel, the method comprising:
   providing the assembly of any one of clauses 1-21, 43-54, or 64-75;
   removing the comb from the assembly; and
   loading one or more samples into one or more wells.
Clause 90. A method for running multiple samples on an electrophoretic gel without band shape distortion in the samples proximate to the gel edges, the method comprising: providing the assembly of any one of clauses 1-21, 43-54, or 64-75;
   removing the comb from the assembly;
   introducing one or more samples into one or more wells; and
   applying an electric current to induce electrophoresis.
Clause 91. A method for casting and loading an electrophoretic gel without excess polymerized gel casting solution contaminating at least one well formed in the polymerized gel in a cassette, the method comprising:
   providing the assembly of any one of clauses 1-21, 43-54, or 64-75;
   introducing a sufficient amount of electrophoresis gel casting solution to fill the cassette, wherein the electrophoresis gel casting solution comprises polyacrylamide, one or more buffers, and optionally a detergent, and wherein polymerization of the electrophoresis gel casting solution has been initiated by an addition of a polymerization initiator and optionally a polymerization accelerator;
   inserting the comb of any one of clauses 22-42, 55-63, or 76-87 into the cassette;
   permitting the electrophoresis gel casting solution to polymerize for a period of time;
   removing the comb from the cassette, wherein up on removal minimal excess polymerized gel casting solution exists in or surrounding one or more wells; and
   loading one or more samples into one or more wells.
Clause 92. A method for detecting low abundant-proteins or proteins in dilute samples by loading large sample volumes:
   providing the assembly of any one of clauses 1-21, 43-54, or 64-75;
   removing the comb from the assembly;
   introducing one or more samples into one or more wells, wherein the wells comprise volumes of 40-100 μL; and
   applying an electric current to induce electrophoresis.
Clause 93. Use of the assembly of any one of clauses 1-21, 43-54, or 64-75 for performing electrophoresis of a sample.
Clause 94. The use of clause 93, wherein the sample is a low abundant-protein or proteins in dilute samples.
Clause 95. Use of the comb of any one of clauses 22-42, 55-63, or 76-87 for casting an electrophoretic gel, wherein wells created by the comb have volumes of about 40-100 μL.
Clause 96. An assembly for gel electrophoresis comprising:
   a gel cassette comprising a retainer plate and a divider plate coupled to form a cavity between the retainer plate and the divider plate; and
   a comb comprising
      an elongated body having a first end and a second end,
      an intermediate portion connected to the elongated body and extending between the first end and the second end, the intermediate portion having a third end adjacent the first end of the elongated body and a fourth end adjacent the second end of the elongated body, and
      a plurality of teeth extending from the intermediate portion between the first end and the second end, the plurality of teeth spaced apart from at least one of the third end and the fourth end,
   wherein the comb is configured to be received in the gel cassette, and
   wherein in response to the comb being received in the gel cassette, the intermediate portion is received in the cavity such that the third and the fourth ends are configured to engage an internal edge of the cavity.
Clause 97. The assembly of clause 96, wherein:
   the plurality of teeth includes a first tooth nearest the third end of the intermediate portion,
   the first tooth has a first width,
   the first tooth is spaced apart from the third end of the intermediate portion by a first distance, and
   the first distance is greater than the first width.
Clause 98. The assembly of clause 97, wherein:
   the plurality of teeth includes a second tooth nearest the fourth end of the intermediate portion,
   the second tooth has a second width,
   the second tooth is spaced apart from the fourth end of the intermediate portion by a second distance, and
   the second distance is greater than the second width.
Clause 99. The assembly of clause 98, wherein the first width is identical to the second width, and wherein the first distance is identical to the second distance.
Clause 100. The assembly of clause 98 or 99, wherein:
   the plurality of teeth includes a third tooth between the first tooth and the second tooth,
   the third tooth has a third width, and
   the third width is greater than the first width and/or the second width.
Clause 101. The assembly of clause 96, wherein each tooth of the plurality of teeth has an identical width.
Clause 102. An assembly for gel electrophoresis comprising:
   a gel cassette configured to accommodate an electrophoresis gel casting solution, the gel cassette including a retainer plate and a divider plate coupled to form a cavity between the retainer plate and the divider plate, the retainer plate having an upper edge adjacent an opening to the cavity; and
   a comb including
      an elongated body having
         a first end,
         a second end opposite the first end, and
         a channel extending between the first end and the second end,
      a plurality of teeth extending from the elongated body between the first end and the second end, and
      a wall extending at least partially around a periphery of the elongated body,
   wherein the comb is configured to be received in the gel cassette, and
   wherein in response to the comb being received in the gel cassette, a portion of the wall is configured to engage the upper edge of the retainer plate.
Clause 103. The assembly of clause 102, wherein the wall extends from a first side of the elongated body, and wherein the channel extends along a second side of the elongated body opposite the first side.
Clause 104. The assembly of clause 102 or 103, wherein the wall includes a rim extending between the first end and the second end and a lip extending between the first end and the second end, and wherein in response to the comb being received in the gel cassette, the rim is configured to engage the upper edge of the retainer plate.
Clause 105. The assembly of clause 104, wherein a recess is defined between the rim and the lip, and wherein the lip improves access to the elongated body to assist removal of the comb from the gel cassette.
Clause 106. The assembly of clause 105, wherein the elongated body includes a sloped surface in the recess and adjacent the rim, and wherein the electrophoresis gel casting solution is configured to flow along the sloped surface and off the comb, and wherein the sloped surface is positioned on a side of the elongated body opposite the channel.
Clause 107. The assembly of any one of clauses 102-106, wherein the retainer plate includes:
   a retainer body,
   an abutment portion extending along the retainer body adjacent the opening, the abutment portion having the upper edge, the abutment portion having tapered edges, and
   a rail extending along the retainer body, the rail spaced apart from the abutment portion, the rail having tapered edges.
Clause 108. The assembly of any one of clauses 102-107, wherein:
   the comb includes an intermediate portion between the elongated body and the plurality of teeth,
   the intermediate portion extends between the first end and the second end of the elongated body,
   the intermediate portion has a third end and a fourth end opposite the third end, and
   in response to the comb being received in the gel cassette, the third and the fourth ends are configured to engage an internal edge of the cavity.

What is claimed:

1. An assembly for gel electrophoresis comprising:
a gel cassette comprising a retainer plate and a divider plate coupled to form a cavity between the retainer plate and the divider plate; and
a comb comprising
an elongated body having a first end and a second end,
an intermediate portion connected to the elongated body and extending between the first end and the second end, the intermediate portion having a third end adjacent the first end of the elongated body and a fourth end adjacent the second end of the elongated body, and
a plurality of teeth extending from the intermediate portion between the first end and the second end, the plurality of teeth spaced apart from at least one of the third end and the fourth end,
wherein the comb is configured to be received in the gel cassette, and
wherein in response to the comb being received in the gel cassette, the intermediate portion is received in the cavity such that the third and the fourth ends are configured to engage an internal edge of the cavity.

2. The assembly of claim 1, wherein:
the plurality of teeth includes a first tooth nearest the third end of the intermediate portion,
the first tooth has a first width,
the first tooth is spaced apart from the third end of the intermediate portion by a first distance, and
the first distance is greater than the first width.

3. The assembly of claim 2, wherein:
the plurality of teeth includes a second tooth nearest the fourth end of the intermediate portion,
the second tooth has a second width,
the second tooth is spaced apart from the fourth end of the intermediate portion by a second distance, and
the second distance is greater than the second width.

4. The assembly of claim 3, wherein the first width is identical to the second width, and wherein the first distance is identical to the second distance.

5. The assembly of claim 3, wherein:
the plurality of teeth includes a third tooth between the first tooth and the second tooth,
the third tooth has a third width, and
the third width is greater than the first width and/or the second width.

6. The assembly of claim 1, wherein each tooth of the plurality of teeth has an identical width.

7. An assembly for gel electrophoresis comprising:
a gel cassette configured to accommodate an electrophoresis gel casting solution, the gel cassette including a retainer plate and a divider plate coupled to form a cavity between the retainer plate and the divider plate, the retainer plate having an upper edge adjacent an opening to the cavity; and
a comb including
an elongated body having
a first end,
a second end opposite the first end, and
a channel extending between the first end and the second end,
a plurality of teeth extending from the elongated body between the first end and the second end, and
a wall extending at least partially around a periphery of the elongated body,
wherein the comb is configured to be received in the gel cassette, and
wherein in response to the comb being received in the gel cassette, a portion of the wall is configured to engage the upper edge of the retainer plate.

8. The assembly of claim 7, wherein the wall extends from a first side of the elongated body, and wherein the channel extends along a second side of the elongated body opposite the first side.

9. The assembly of claim 7, wherein the wall includes a rim extending between the first end and the second end and a lip extending between the first end and the second end, and wherein in response to the comb being received in the gel cassette, the rim is configured to engage the upper edge of the retainer plate.

10. The assembly of claim 9, wherein a recess is defined between the rim and the lip, and wherein the lip improves access to the elongated body to assist removal of the comb from the gel cassette.

11. The assembly of claim 10, wherein the elongated body includes a sloped surface in the recess and adjacent the rim, and wherein the electrophoresis gel casting solution is configured to flow along the sloped surface and off the comb, and wherein the sloped surface is positioned on a side of the elongated body opposite the channel.

12. The assembly of claim 7, wherein the retainer plate includes:
a retainer body,
an abutment portion extending along the retainer body adjacent the opening, the abutment portion having the upper edge, the abutment portion having tapered edges, and
a rail extending along the retainer body, the rail spaced apart from the abutment portion, the rail having tapered edges.

13. The assembly of claim 7, wherein:
the comb includes an intermediate portion between the elongated body and the plurality of teeth,
the intermediate portion extends between the first end and the second end of the elongated body,
the intermediate portion has a third end and a fourth end opposite the third end, and
in response to the comb being received in the gel cassette, the third and the fourth ends are configured to engage an internal edge of the cavity.

14. A comb for gel electrophoresis comprising:
an elongated body including a first end and a second end;
a wall extending at least partially around a periphery of the elongated body;
an intermediate portion connected to the wall and extending between the first end and the second end of the elongated body, the intermediate portion having a third end and a fourth end opposite the third end, the third end adjacent the first end of the elongated body, the fourth end adjacent the second end of the elongated body; and
a plurality of teeth extending from the intermediate portion between the third end and the fourth end, the plurality of teeth spaced apart from at least one of the third end and the fourth end.

15. The comb of claim 14, wherein:
the plurality of teeth includes a first tooth nearest the third end of the intermediate portion,
the first tooth has a first width,
the first tooth is spaced apart from the third end of the intermediate portion by a first distance, and
the first distance is greater than the first width.

16. The comb of claim 15, wherein:
the plurality of teeth includes a second tooth nearest the fourth end of the intermediate portion,
the second tooth has a second width,
the second tooth is spaced apart from the fourth end of the intermediate portion by a second distance, and
the second distance is greater than the second width.

17. The comb of claim 16, wherein:
the plurality of teeth includes a third tooth between the first tooth and the second tooth,
the third tooth has a third width, and
the third width is greater than the first width and the second width.

18. The comb of claim 14, wherein each tooth of the plurality of teeth has an identical width.

19. The comb of claim 14, wherein each tooth of the plurality of teeth includes a first portion and a second portion on a side of the first portion opposite the intermediate portion, and wherein the second portion is angled relative to the first portion.

20. The comb of claim 19, wherein:
each tooth of the plurality of teeth includes a third portion on a side of the second portion opposite the first portion,
the first portion defines a first planar surface,
the third portion defines a third planar surface, and
the first planar surface is parallel to the third planar surface.
